(19) United States
(12) Patent Application Publication
(10) Pub. No.: US 2019/0121518 A1
(43) Pub. Date: Apr. 25, 2019

(54) Presentation of Stream Content Related to a Canonical Identifier

(71) Applicant: Google Inc., Mountain View, CA (US)

(72) Inventors: Mario Ventura Anima, Sunnyvale, CA (US); Vitor Rodrigues, San Jose, CA (US); Jeffrey A. Craig, Baton Rouge, LA (US); Prasenjit Sarkar, Sunnyvale, CA (US)

(73) Assignee: Google Inc., Mountain View, CA (US)

(21) Appl. No.: 14/184,880

(22) Filed: Feb. 20, 2014

(51) Int. Cl. G06F 3/0484

(52) U.S. Cl. CPC G06F 3/04842

(57) ABSTRACT

A system comprising a processor and a memory storing instructions that, when executed, cause the system to receive an input related to a widget on a website; receive a canonical identifier from the widget; determine an identification for a user; determine a social signal for the identified user; produce a stream of related content using the canonical identifier, the identification and the social signal; generate a user interface element for display of the stream of related content; and provide the user interface element for presentation to the user. The disclosure also includes similar methods and computer program products.

### BACKGROUND

The present disclosure relates to presenting stream content related to a canonical identifier. In particular, the present disclosure relates to a user interface element for presentation and interaction with stream content related to the canonical identifier.

The popularity and use of the Internet, web browsers, social networks and other types of electronic communication has grown dramatically in recent years. In particular, social networks now include a great amount of content including posts, images, endorsements, activity, videos, etc. Users are interested in viewing content related to particular web pages or other web information from other sources, but there is are only limited ways presently to view information from social networks in other contexts. Typically the user must switch between browser windows for viewing the web page and for a social network. However, it remains difficult to secure and view content related to a particular web page or URL other than the webpage itself.

### SUMMARY

The present disclosure relates to systems and methods for presenting and interacting with stream content related to the canonical identifier. According to one innovative aspect of the subject matter in this disclosure, a system having one or more processors and a memory storing instructions that, when executed, cause the system to: receive an input related to a widget on a website; receive a canonical identifier from the widget; determine an identification for a user; determine a social signal for the identified user; produce a stream of related content using the canonical identifier, the identification and the social signal; generate a user interface element for display of the stream of related content; and provide the user interface element for presentation to the user.

In general, another innovative aspect of the subject matter described in this disclosure may be implemented in methods that include receiving, using one or more processors, an input related to a widget on a website; receiving, using the one or more processors, a canonical identifier from the widget; determining, using the one or more processors, an identification for a user; determining, using the one or more processors, a social signal for the identified user; producing, using the one or more processors, a stream of related content using the canonical identifier, the identification and the social signal; generating, using the one or more processors, a user interface element for display of the stream of related content; and providing, using the one or more processors, the user interface element for presentation to the user.

Other implementations of one or more of these aspects include corresponding systems, apparatus, and computer programs, configured to perform the actions of the methods, encoded on computer storage devices.

These and other implementations may each optionally include one or more of the following features. For example, the input is user interaction with the widget or user selection of the widget, or the canonical identifier is a uniform resource locator. For instance, the operations may further include: receiving additional input related to the user interface element; creating a message including the canonical identifier; and sending the message including the canonical identifier. The operations may also include receiving a request to endorse identified content; creating an endorsement using the request; and sending the endorsement. In some instances, the operations may further include: receiving a request to additional activity; determining activity related to the canonical identifier; and updating the user interface element to show activity related to the canonical identifier; or receiving a request to report abuse; identifying a post associated with the request; identifying a second user that authored the post; and removing one or more posts of the second author the stream of content.

These implementations are particularly advantageous in a number of respects. For instance, the technology described herein can present a stream of content, messages or posts, related to a website in a seamless manner. Additionally, the system generates a user interface element that presents the stream of content as well as allows the user to interact with the stream of content and perform social network actions without leaving the webpage. It should be understood, however, that this list of features and advantages is not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a high-level block diagram illustrating an example system for presenting stream content related to a canonical identifier.

FIG. 2 is a block diagram illustrating an example social network server including an embedded stream widget module.

FIG. 3 is a block diagram illustrating an example embedded stream widget module stored on the social network server.

FIG. 4 is a flow chart of an example method for presenting stream content related to a canonical identifier.

FIG. 5 is a flow chart of an example method for interacting with stream content related to a canonical identifier.

FIGS. 6A and 6B are a flow chart illustrating another example method for interacting with stream content related to a canonical identifier.

FIGS. 7 and 8 are graphic representations of an example web page including one implementation of an embedded stream widget.

FIGS. 9-20 are graphic representations of an example web page including a user interface element according to some implementations of the present disclosure.

### DETAILED DESCRIPTION

Systems, methods and interfaces for presenting stream content related to a canonical identifier are disclosed. While the systems, methods and interfaces of the present disclosure are described in the context of web pages and showing related posts from a social network, it should be understood that the systems, methods and interfaces can be applied to other system external to the social network for presenting stream content related to a canonical identifier such as email, endorsement, etc.

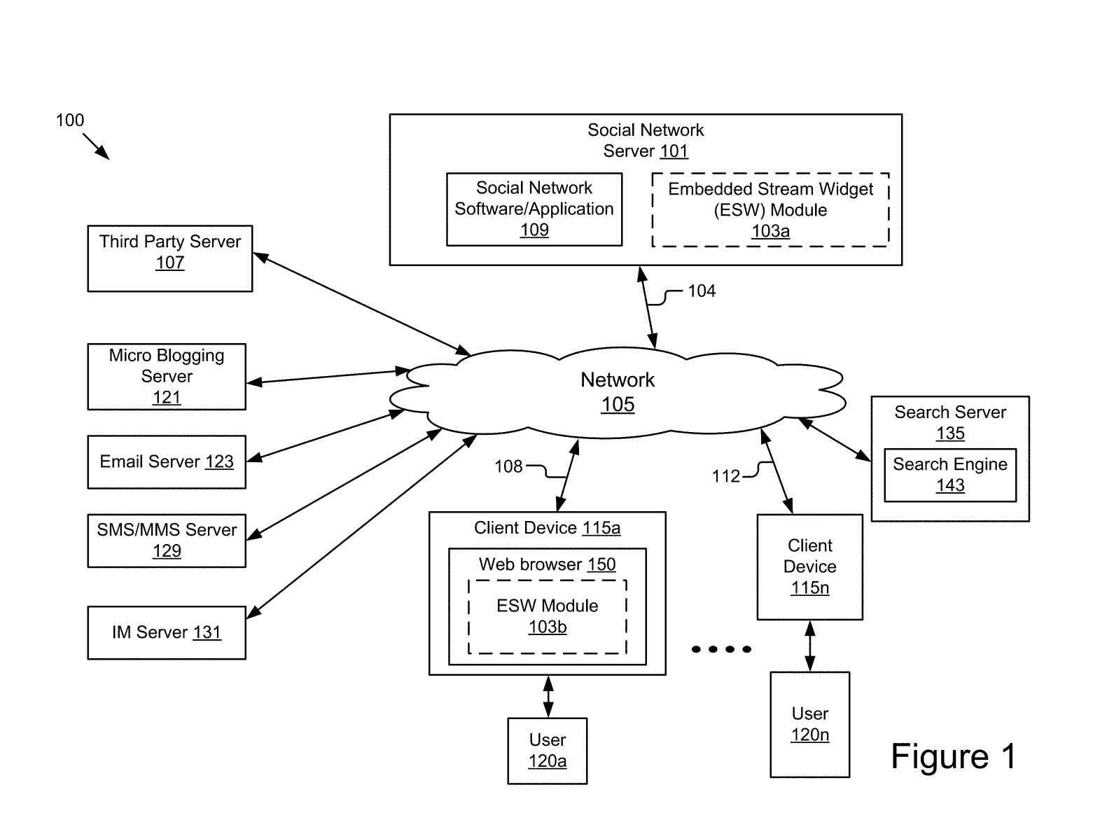

FIG. 1 illustrates a high-level block diagram of a system 100 for presenting stream content related to a canonical identifier according to some implementations of the present disclosure. The illustrated system 100 includes client devices 115a-115n (also referred to herein individually and collectively as 115) that are accessed by users 120a-120n (also referred to herein individually and collectively as 120), a social network server 101 having a social network application 109 and an embedded stream widget module 103a (also referred to herein individually and collectively as 103). The system 100 also includes a number of products or services offered by a third party server 107, a micro blogging server 121, an email server 123, a Short Message Service (SMS)/Multimedia Messaging Service (MMS) server 129, an Instant Messaging (IM) server 131 and a search server 135. In the illustrated implementation, these entities are communicatively coupled via a network 105. These systems 101, 107, 121, 123, 129, 131, 135 are merely examples and the system 100 in some implementations includes an advertisement server, a document server, a blogging server, a news feed server, a video sharing server, a photo sharing server, a map server and any other third party server, etc.

The client devices 115a-115n in FIG. 1 are used by way of example. While FIG. 1 illustrates two client devices 115a and 115n, the present disclosure applies to any system architecture having one or more client devices 115. Furthermore, while only one network 105 is coupled to the client devices 115a-115n, the social network server 101, the third party server 107, the micro blogging server 121, the email server 123, the Short Message Service (SMS)/Multimedia Messaging Service (MMS) server 129, the Instant Messaging (IM) server 131 and the search server 135, in practice one or more networks 105 can be connected to these entities. Furthermore, while only one the third party server 107 is shown, the system 100 can include one or more the third party servers 107. Furthermore, while only one social network server 101 is shown, the system 100 can include one or more social network servers 101.

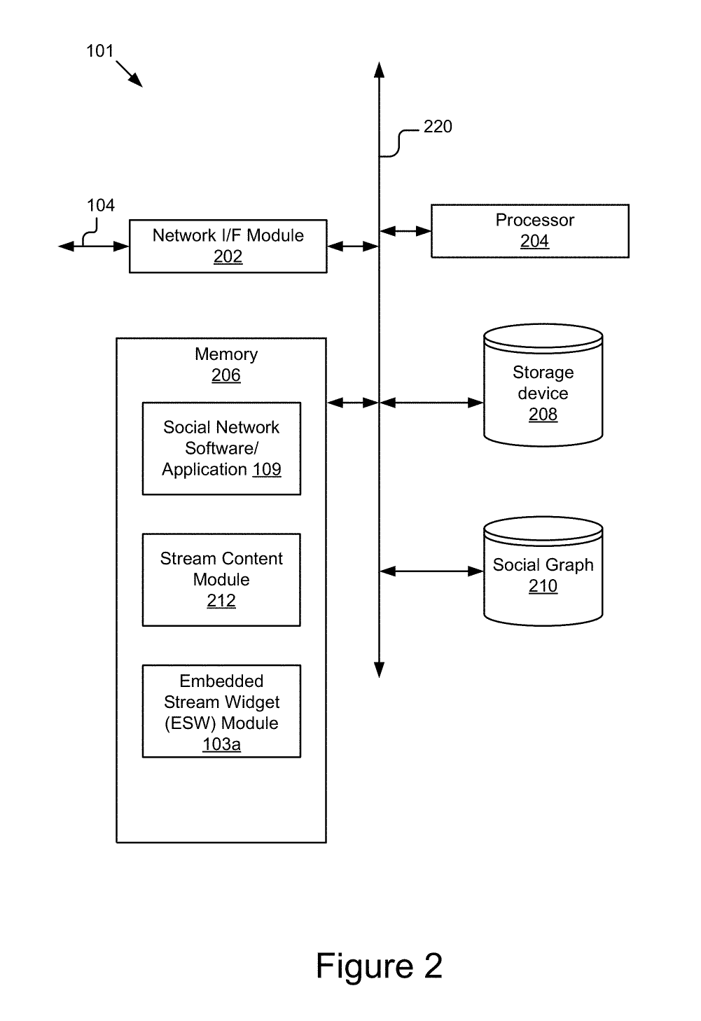

While shown as operational on the social network server 101 in FIG. 1, in some implementations all or part of the embedded stream widget module 103b may be operational on the one or more of the client devices 115, or the third party server 107. The embedded stream widget module 103 interacts with the servers 173, 101, 115 and 107 via the network 105. The embedded stream widget module 103 is also coupled for communication with the client device 115a, which is connected to the network 105 via signal line 108. The user 120a interacts with the client device 115a. Similarly, the client device 115n is coupled to the network 105 via signal line 112 and the user 120n interacts with the client device 115n. The user 120 is a human user of the client device 115. It should be recognized that the embedded stream widget module 103 can be stored in any combination of the devices and servers, or in only one of the devices or servers. The embedded stream widget module 103 will be describe in more detail with reference to FIGS. 2-6B.

The social network server 101 is coupled to the network 105 via signal line 104 for communication and cooperation with the other components of the system 100. In some implementations, the social network server 101 includes the social network software/application 109. Although only one social network server 101 is shown, it should be recognized that multiple servers may be present. A social network may be any type of social structure where the users 120 are connected by a common feature. The common feature includes relationships/connections, e.g., friendship, family, work, an interest, etc. The common features are provided by one or more social networking systems, for example, those included in the system 100, including explicitly-defined relationships and relationships implied by social connections with other online users, where the relationships form a social graph. In some examples, the social graph can reflect a mapping of these users and how they are related. The phrase social graph as used herein encompasses its plain and ordinary meaning including, but not limited to, a file that includes the relationships between the users in a social network. For example, users can be friends, acquaintances, have business relationships, one user can follow another user, one user can subscribe to another user, share with other users or a specific user, etc. Furthermore, it should be understood that the social network server 101 and the social network software/application 109 are representative of one social network and that there may be multiple social networks coupled to the network 105, each having its own server, application and social graph. For example, a first social network may be more directed to business networking, a second may be more directed to or centered on academics, a third may be more directed to local business, a fourth may be directed to dating and others of general interest or a specific focus.

In some implementations, the social network server 101 receives and sends data and social information provided by the other servers 107, 121, 123, 129, 131 and 135. For example, the social network server 101 receives and sends any social information or events performed on any web pages and/or applications hosted by the servers 107 121, 123, 129, 131 and 135. The web pages and/or applications include a user interface allowing a user 120 to respond to, comment or endorse a product, a video, a search result, a widget, a post, a comment, a photo, an article, etc., shown on the web pages and/or applications.

In some implementations, the social network server 101, the third party server 107, the Micro Blogging server 121, the email server 123, the SMS/MMS server 129, the IM server 131 and the search server 135 are hardware servers including a processor, a memory, and network communication capabilities.

The client devices 115 can be any computing device including one or more memory and one or more processors, for example, a laptop computer, a desktop computer, a tablet computer, a mobile telephone, a personal digital assistant (PDA), a mobile email device, a portable game player, a portable music player, a television with one or more processors embedded therein or coupled thereto or any other electronic device capable of accessing a network. In some implementations, the system 100 includes a combination of different types of client devices 115. For example, a combination of a personal computer and a mobile phone. As will be described below, it should be understood that the present technologies can operate on different models other than a client-server architecture. For example, the client devices 115 may include the embedded stream widget module 103 and include different services. The client device 115 will be described in more detail with reference to FIG. 2.

The browser 150 can be a web browser stored on the on the client device 115 and configured for two-way communications with the servers 173, 101, 107, 121, 123, 129, 131 and 135. For example, the browser 150 is a software application for retrieving, presenting and traversing information resources on the web. In the illustrated implementation, the browser 150 includes an embedded stream widget module 103b.

The network 105 enables communications between the client devices 115a-n, the social network server 101, the third party server 107, the Micro Blogging server 121, the email server 123, the SMS/MMS server 129, the IM server 131 and the search server 135. Thus, the network 105 can include links using technologies including, for example, Wi-Fi, Wi-Max, 2G, Universal Mobile Telecommunications System (UMTS), 3G, Ethernet, 802.11, integrated services digital network (ISDN), digital subscriber line (DSL), asynchronous transfer mode (ATM), InfiniBand, PCI Express Advanced Switching, etc. Similarly, the networking protocols used on the network 105 can include the transmission control protocol/Internet protocol (TCP/IP), multi-protocol label switching (MPLS), the User Datagram Protocol (UDP), the hypertext transport protocol (HTTP), the simple mail transfer protocol (SMTP), the file transfer protocol (FTP), lightweight directory access protocol (LDAP), Code Division Multiple Access (CDMA), Wideband Code Division Multiple Access (WCDMA), Global System for Mobile communications (GSM), High-Speed Downlink Packet Access (HSDPA), etc. The data exchanged over the network 105 can be represented using technologies and/or formats including the hypertext markup language (HTML), the extensible markup language (XML), etc. In addition, all or some of links can be encrypted using conventional encryption technologies, for example, the secure sockets layer (SSL), Secure HTTP and/or virtual private networks (VPNs) or Internet Protocol security (IPsec). In some implementations, the entities can use custom and/or dedicated data communications technologies instead of, or in addition to, the ones described above. Depending upon the implementation, the network 105 can also include links to other networks.

In some implementations, the network 105 is a partially public or a wholly public network, for example, the Internet. The network 105 can also be a private network or include one or more distinct or logical private networks (e.g., virtual private networks, Wide Area Networks (“WAN”) and/or Local Area Networks (“LAN”)). Additionally, the communication links to and from the network 105 can be wired or wireless (i.e., terrestrial or satellite-based transceivers). In some implementations, the network 105 is an IP-based wide or metropolitan area network.

The network 105 may have any number of configurations including a star configuration, token ring configuration or other configurations. Furthermore, the network 105 may include a local area network (LAN), a wide area network (WAN) (e.g., the Internet), and/or any other interconnected data path across which multiple devices may communicate. In some implementations, the network 105 may be a peer-to-peer network. The network 105 may also be coupled to or include portions of a telecommunications network for sending data in a variety of different communication protocols. In some implementations, the network 105 includes short-wavelength communication networks or a cellular communications network for sending and receiving data including via short messaging service (SMS), multimedia messaging service (MMS), hypertext transfer protocol (HTTP), direct data connection, wireless application protocol (WAP), electronic messages, etc.

FIG. 2 illustrates the social network server 101 according to some implementations of the present disclosure. In the illustrated implementations, the social network server 101 includes the network interface (I/F) module 202, a processor 204, a memory 206, a storage device 208 and a social graph 210. These components of the social network server 101 are communicatively coupled to a bus or software communication mechanism 220 for communication with each other.

The network interface module 202 is coupled to the network 105 by signal line 104. The network interface module 202 is also coupled to the bus 220. The network interface module 202 includes ports for wired connectivity including but not limited to USB, SD, or CAT-5, etc. The network interface module 202 links the processor 204 to the network 105 that may in turn be coupled to other processing systems. The network interface module 202 provides other conventional connections to the network 105 using standard network protocols, e.g., TCP/IP, HTTP, HTTPS and SMTP. In some implementations, the network interface module 202 includes a transceiver for sending and receiving signals using WiFi, Bluetooth® or cellular communications for wireless communication.

The processor 204 may include an arithmetic logic unit, a microprocessor, a general purpose controller or some other processor array to perform computations and provide electronic display signals to a display device. In some implementations, the processor 204 is a hardware processor. The processor 204 is coupled to the bus 220 for communication with the other components. Processor 204 processes data signals and may include various computing architectures including a complex instruction set computer (CISC) architecture, a reduced instruction set computer (RISC) architecture, or an architecture implementing a combination of instruction sets. Although only a single processor is shown in FIG. 2A, multiple processors may be included. It should be understood that other processors, operating systems, sensors, displays and physical configurations are possible.

The memory 206 stores instructions and/or data that may be executed by the processor 204. In the illustrated implementation, the memory 206 stores the social network software/application 109, the stream content module 212 and the embedded stream widget module 103a. The memory 206 is coupled to the bus 220 for communication with the other components of the social network server 101. The instructions and/or data may include code for performing any and/or all of the techniques described herein. The memory 206 may be a dynamic random access memory (DRAM) device, a static random access memory (SRAM) device, flash memory or some other memory devices.

The storage device 208 may be a non-transitory memory that stores data. For example, the storage device 208 may be a dynamic random access memory (DRAM) device, a static random access memory (SRAM) device, flash memory or some other memory device. In some implementations, the storage device 208 also includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device. In some implementations, the storage device 208 stores data received from and sent to users 120 to accomplish the functionalities described herein of the embedded stream widget module 103a.

Software communication mechanism 220 may be an object bus (e.g., CORBA), direct socket communication (e.g., TCP/IP sockets) among software modules, remote procedure calls, UDP broadcasts and receipts, HTTP connections, function or procedure calls, etc. Further, any or all of the communication could be secure (SSH, HTTPS, etc). The software communication mechanism 220 can be implemented on any underlying hardware, for example, a network, the Internet, a bus, a combination thereof, etc.

The stream content module 212 can be software or routines for generating a stream of content tailored or particular to the user. In FIG. 2, the stream content module 212 is shows as a module operational a part of memory 206. In some implementations, the stream content module 212 may be part of the social network application 109. The social network application 109 may cooperate with the social network application 109 to generate and provide the stream of content. Based upon the user's interests, social graph, interactions and other factors, the stream content module 222, may generate a stream of content tailored to the user. The stream content module 212 may be software including routines for generating and providing the stream of content. In some implementations, the stream content module 212 may be a set of instructions executable by the processor 204 to provide the functionality described herein for generating and providing the stream of content. In some implementations, the stream content module 212 may be stored in the memory 206 of the server 101 and is accessible and executable by the processor 204. In some implementations, the stream content module 212 may be adapted for cooperation and communication with the processor 204 and other components of the server 101 via bus 220.

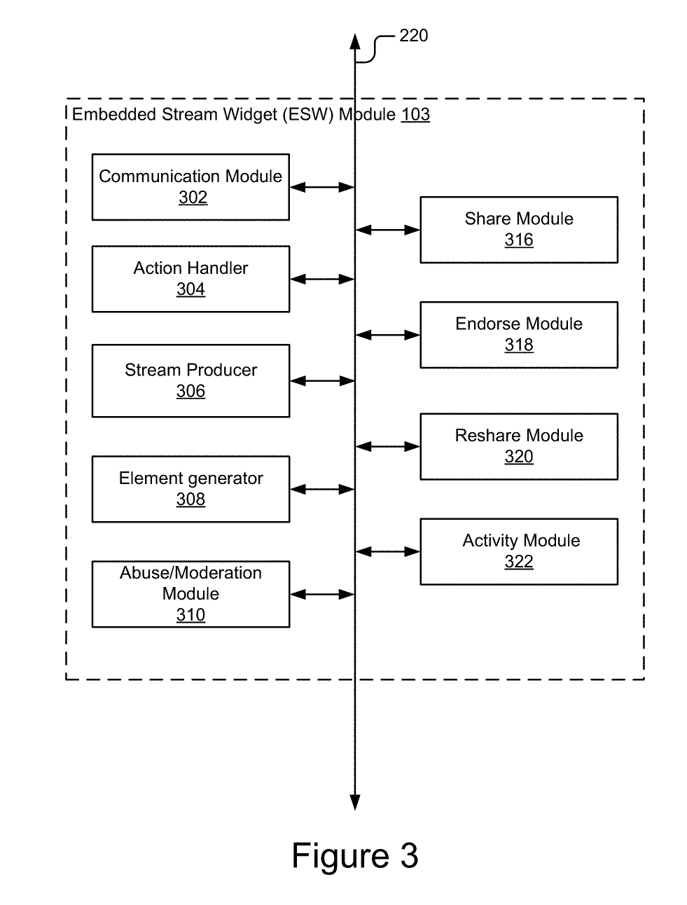

The embedded stream widget module 103a generates a user interface element for presentation and interaction with stream content related to the canonical identifier. In some implementations, the embedded stream widget module 103a is responsive to a signal from a widget and signals from the user via the web browser 150. For example, the widget may be embedded as part of a web site or page. When a user interacts with portions of the web page, the widget generates a signal including a canonical identifier. The embedded stream widget module 103a receives and processes the signal from the widget and generate a user interface element that is sent the client device and which the user may interact. The user interface element can generate other signals, present a stream of content and initiate other actions related to the social network, for example, posting, sharing, resharing, endorsing, etc. The operation of the embedded stream widget module 103a will be described in more detail with reference to FIGS. 3-6A. In some implementations, the embedded stream widget module 103a may interacts with widgets on other servers including the third party server 107, the Micro Blogging server 121, the email server 123, the SMS/MMS server, the IM server 131, the search server 135 and any other entities (not pictured) that can be included in the system 100.

In some implementations, the embedded stream widget module 103a determines a social signal or receives a social signal from the social network application 101 based on the received data associated with the user 120. For example, the social network application 101 or receives social data describing user social activities, endorsements, and status and determines a social signal based on the social data. For example, the embedded stream widget module 103a can filter the received social data and determine a social signal relevant to the user 120. For example, a social signal may be a signal indicating a recent social activity performed by the user 120 or social connections of the user 120 (e.g., followers, friends, family, etc.). For example, a social signal indicates that the user 120 has just submitted a post about a new car. For example, a social signal may indicate that a friend of the user's has updated the status as graduated from school.

In some implementations, the embedded stream widget module 103a determines one or more interests of the user 120 based on one or more of the social signal, the location, the context and the search data associated with the user 120. In some implementations, the embedded stream widget module 103a receives a social signal from the social network application 101 that includes one or more interests of the user. The embedded stream widget module 103a can then use this signal to determine relevant social content (e.g., relevant posts on social networks) to provide to the user 120. In some implementations, the embedded stream widget module 10a can also rank the relevant social content based on the relevance and provide the user 120 with social content that has a ranking above a predetermined threshold. In some implementations, the embedded stream widget module 103 includes the ranked content in the user interface element and provides the user interface element which may include information, formatting data, layout data, selectable links for actions or tasks, as well as other information necessary to execute such actions or tasks.

Referring now to FIG. 3, the embedded stream widget module 130a is described in more detail according to some implementations. The embedded stream widget module 130a includes a communication module 302, an action handler 304, a stream producer 306, an element generator 308, an abuse/moderation module 310, a post module 314, a share module 316, an endorse module 318, a reshare module 320 and an activity module 322. Each of these components is coupled to the software communication mechanism 220 for communication with each other and the other components of the social network server 101.

The communication module 302 can be software or routines for handling communications between the action handler 304, the stream producer 306, the element generator 308, the abuse/moderation module 310, the post module 314, the share module 316, the endorse module 318, the reshare module 320 and the activity module 322. The communication module 302 also facilitates communication with the other components of the social network server 101 as well as communication with the other components of the system 100 via the network interface module 202 and the network 105. For example, the communication module 302 may send signal between widgets, browsers and other devices, and the components of the embedded stream widget module 103. In some implementations, the communication module 302 is a set of instructions executable by the processor 204. In some implementations, the communication module 302 is stored in the memory 206 of the social network server 101 and is accessible and executable by the processor 204. In some implementations, the communication module 302 is adapted for cooperation and communication with the processor 204, the memory 206 and other components of the embedded stream widget module 103a via the bus 220.

The action handler 304 can be software or routines for receiving a request or other information from a widget. For example, the action handler 304 receives a request generated by a widget including the canonical identifier. The action handler 304 then initiates a process to generate a user interface element that includes stream content related to the canonical identifier. The action handler 304 receives other input related to presentation of the user interface element; and generates and sends signals to the other components of the embedded stream widget module 103 to update the user interface element or take an action related to the stream of content related to the canonical identifier. In some implementations, the action handler 304 is a set of instructions executable by the processor 204. In some implementations, the action handler 304 is stored in the memory 206 of the social network server 101 and is accessible and executable by the processor 204. In some implementations, the action handler 304 is adapted for cooperation and communication with the processor 204, the memory 206 and other components of the embedded stream widget module 103a via the bus 220.

The stream producer 306 can be software or routines for generating a stream of content related to the canonical identifier. The stream producer 306 is coupled for communication with the action handler 306. The action handler 304 sends the canonical identifier included in the request from the widget to the stream producer 306. The stream producer 306 uses the canonical identifier to generate a stream of content. The stream producer 306 is also coupled for communication with the social network application 109 to retrieve content items. In some implementations the stream producer 306 is coupled to other systems to retrieve other content items related to the canonical identifier from other sources. In some implementations, the stream producer generates a stream of related content using the canonical identifier, the identification of the user and the social signal. The identification of the user can be based upon information retrieved by the embedded stream widget module 103 from the social network application 109 or from the web browser 150 based upon the user log in the registration with a profile server. The identification of the user can be based on other factors including frequently used Internet addresses, location, device identification numbers, etc. In some implementations, the stream producer 306. In some implementations, the stream producer 306 retrieves the social signal from the social network software/application 109. In some implementations, the stream producer 306 generates the social signal. In some implementations, the stream producer 306 is a set of instructions executable by the processor 204. In some implementations, the stream producer 306 is stored in the memory 206 of the social network server 101 and is accessible and executable by the processor 204. In some implementations, the stream producer 306 is adapted for cooperation and communication with the processor 204, the memory 206 and other components of the embedded stream widget module 103a via the bus 220.

In some implementations, the stream producer 306 also determines relevant content items from the stream of content for the user. For example, the stream of content for the user may be retrieved from the stream content module 212. The stream of content will have a plurality of content items related to the canonical identifier. The stream producer 306 then identifies or filters the plurality of content items based upon a social signal for the user. That social signal may be interest of the user, activities of the user, location, a relationship of the user to other users, commenters, social graph, people using the URL, or any other social signal generated by the social network application that can be used to prioritize and filter the related stream of content items. In some implementations, the stream producer 306 also ranks one or more relevant content items by relevance to the user. In some implementations, the stream producer 306 ranks the one or more relevant content items by relevance to the user, then selects relevant content items with a ranking above a predefined threshold for presentation as part of the user interface element.

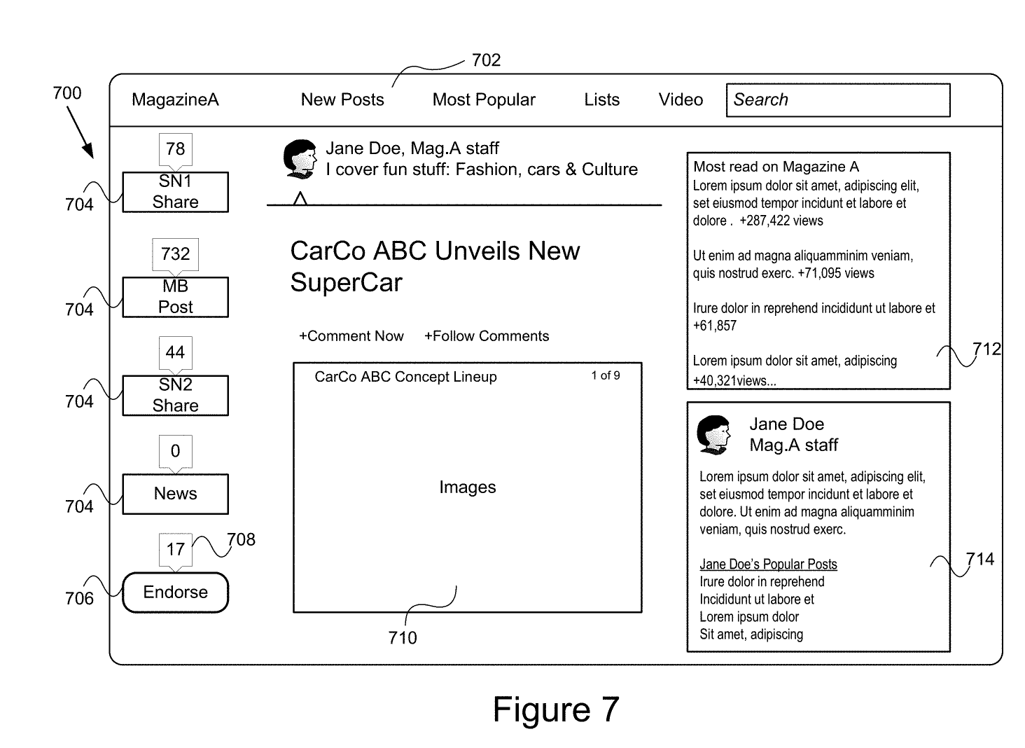

The element generator 308 can be software or routines for generating the user interface element. The element generator 308 also generates updates to the user interface element. The element generator 308 is coupled to receive an initiation signal from the action handler 304 and the stream of content items related to the canonical identifier from the stream producer 306. The element generator 308 generates a user interface that includes the stream of content items related to the canonical identifier. Example user interface elements produced by the element generator 308 are shown and described in more detail below with reference to FIGS. 7-20. The element generator 308 also receives inputs from the user via the action handler 304 or directly from the web browser 150 and updates the user interface element. The element generator 308 also cooperates with the abuse/moderation module 310, the post module 314, the share module 316, the endorsement 318, the re-share module 320 and the activity module 322 to receive changes to the user interface element and actions or other devices to take or initiate actions related to the content items. The element generator 308 processes these changes to produce updates to the user interface element. In some implementations, the element generator 308 creates a user interface element that is a side overlay that can be positioned over a portion of a webpage and the user interface element includes ranked content and information including formatting data, layout data, selectable links for actions or tasks, as well as other information necessary to execute such actions or tasks. In some implementations, the element generator 308 is a set of instructions executable by the processor 204. In some implementations, the element generator 308 is stored in the memory 206 of the social network server 101 and is accessible and executable by the processor 204. In some implementations, the element generator 308 is adapted for cooperation and communication with the processor 204, the memory 206 and other components of the embedded stream widget module 103a via the bus 220.

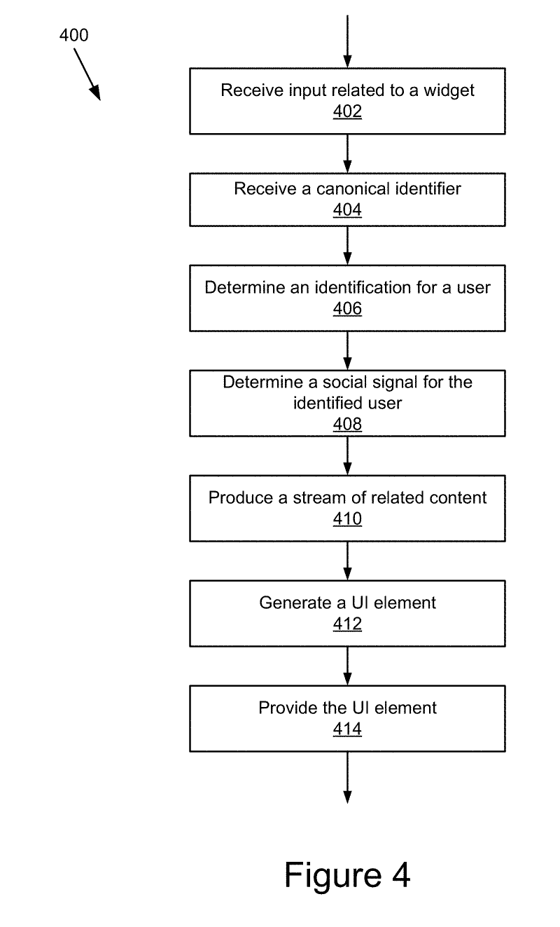

The abuse/moderation module 310 can be software or routines for generating updates to the user interface element related to abuse or moderation of commenting by users. The abuse/moderation module 310 also processes input signals to determine related posts, identify the author that is engaged in abusive behavior or needs moderation, to update groups of a user in the social network application or to report abuse. The abuse/moderation module 310 is coupled to receive input from the user via the action handler 304 or directly from the web browser 150. The abuse/moderation unit 310 is also coupled to provide updates to the user interface element to the element generator 308. The operation of the abuse/moderation module 310 is described in more detail below with reference to FIGS. 4, 5 and 6B. In some implementations, the abuse/moderation module 310 is a set of instructions executable by the processor 204. In some implementations, the abuse/moderation module 310 is stored in the memory 206 of the social network server 101 and is accessible and executable by the processor 204. In some implementations, the abuse/moderation module 310 is adapted for cooperation and communication with the processor 204, the memory 206 and other components of the embedded stream widget module 103a via the bus 220.

The share module 316 can be software or routines for generating updates to the user interface element related to sharing a webpage, or posting a new comment by the user. The share module 316 also processes an input signal to send sharing the webpage, or posting the new comment to the social network 109 or other resource. In some implementations, the new post or comment includes the canonical identifier and the share module 316 creates the new post. The share module 316 is coupled to receive input from the user via the action handler 304 or directly from the web browser 150. The share module 316 is also coupled to provide updates to the user interface element to the element generator 308. The operation of the share module 316 is described in more detail below with reference to FIGS. 4, 5 and 6A. In some implementations, the share module 316 is a set of instructions executable by the processor 204. In some implementations, the share module 316 is stored in the memory 206 of the social network server 101 and is accessible and executable by the processor 204. In some implementations, the share module 316 is adapted for cooperation and communication with the processor 204, the memory 206 and other components of the embedded stream widget module 103a via the bus 220.

The endorse module 318 can be software or routines for generating updates to the user interface element related to endorsements. Additionally, the endorsement module 318 processes input signals to create an endorsement for a webpage or create an endorsement for a comment related to a webpage. The endorsement module 318 is coupled to receive input from the user via the action handler 304 or directly from the web browser 150. The endorsement module 318 is also coupled to provide updates to the user interface element to the element generator 308. The operation of the endorsement module 318 is described in more detail below with reference to FIGS. 4, 5 and 6A. In some implementations, the endorse module 318 is a set of instructions executable by the processor 204. In some implementations, the endorse module 318 is stored in the memory 206 of the social network server 101 and is accessible and executable by the processor 204. In some implementations, the endorse module 318 is adapted for cooperation and communication with the processor 204, the memory 206 and other components of the embedded stream widget module 103a via the bus 220.

The reshare module 320 can be software or routines for generating updates to the user interface element related to a re-share and processing input to generate and send a message to re-share a comment or post. For example, the re-share module 320 determines an original post, updates the user interface element, receives input, creates a re-share comment with the original post and received input, then generates and sends the re-share comment. The re-share module 320 is coupled to receive input from the user via the action handler 304 or directly from the web browser 150. The re-share module 320 is also coupled to provide updates to the user interface element to the element generator 308. The operation of the re-share module 320 is described in more detail below with reference to FIGS. 4, 5 and 6B. In some implementations, the reshare module 320 is a set of instructions executable by the processor 204. In some implementations, the reshare module 320 is stored in the memory 206 of the social network server 101 and is accessible and executable by the processor 204. In some implementations, the reshare module 320 is adapted for cooperation and communication with the processor 204, the memory 206 and other components of the embedded stream widget module 103a via the bus 220.

The activity module 322 can be software or routines for determining activity related to the canonical identifier, generating a related activity list, and generating updates to the user interface element to present the related activity list. The activity module 322 is coupled to receive input from the user via the action handler 304 or directly from the web browser 150. The activity module 322 is also coupled to provide updates to the user interface element to the element generator 308. The operation of the activity module 322 is described in more detail below with reference to FIGS. 4, 5 and 6A. In some implementations, the activity module 322 is a set of instructions executable by the processor 204. In some implementations, the activity module 322 is stored in the memory 206 of the social network server 101 and is accessible and executable by the processor 204. In some implementations, the activity module 322 is adapted for cooperation and communication with the processor 204, the memory 206 and other components of the embedded stream widget module 103a via the bus 220.

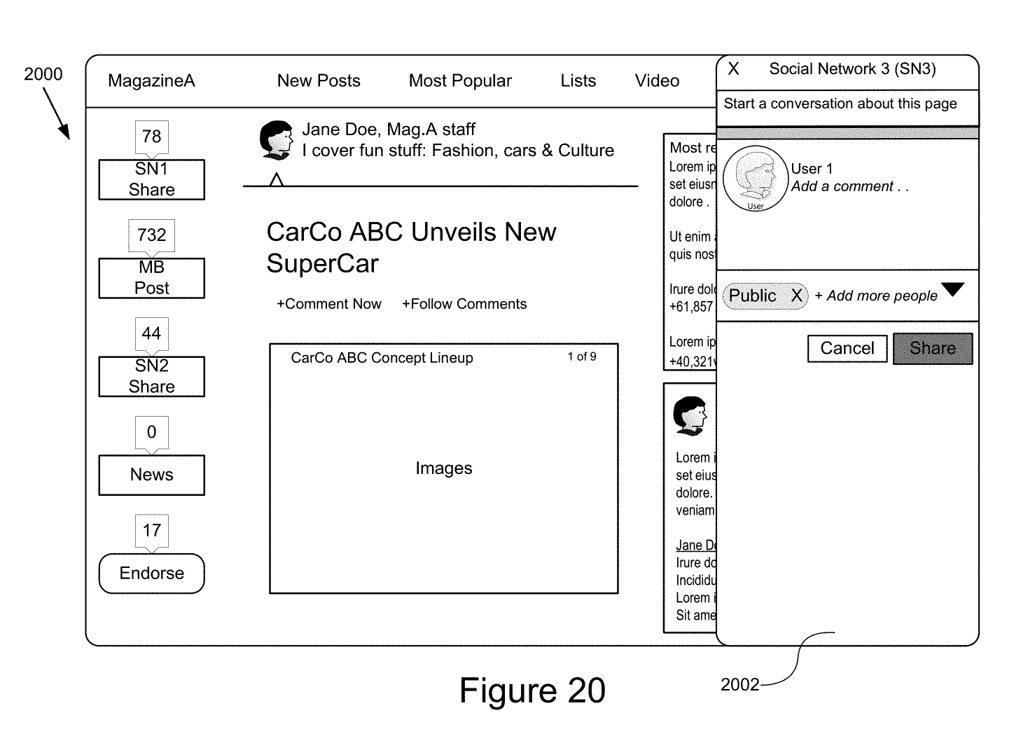

Referring now to FIG. 4, a method 400 for presenting and interacting with a stream content related to the canonical identifier is described. The method 400 begins by receiving 402 an input related to a widget on a website. For example, the widget may be a tag and associated JavaScript that is added or embedded into any third-party webpage. When the webpage is loaded into a browser 150, the widget may be rendered as part of an I-frame. As the user interacts with the widget, the widget will generate a request that includes a canonical identifier, for example, the uniform resource locator (URL) for the webpage. Next, the method 400 receives 404 the canonical identifier from the widget. This request including the uniform resource locator is the input received in block 402 and the canonical identifier is received in block 404. It should be understood, that in some implementations, block 402 and 404 are a single step. The method 400 continues by determining 406 an identification for a user. For example, the embedded stream widget module 103 may interact the social network application 109, the web browser 150 or a profile server (not shown) to determine whether the user has logged in and therefore a login can be used to determine the identity of the user. Alternatively, other information such as IP address, a location, a device identification number, etc. may be used to identify the user. In some embodiments, this step may be optional. The method 400 continues by determining 408 a social signal for the identified user. For example, the embedded stream widget module 103 may retrieve a social signal from the social network application. Example social signals include the social network of the user, an interest of the user, an activity of the user, a relationship of the user to other users, a comment of the user, time or recency, a preference of the user, etc. or combinations thereof. The method 400 continues by producing 410 a stream of related content based upon the canonical identifier. For example, the embedded stream widget module 103 may retrieve content items related to the URL. In other words, the method retrieves conversations, posts, shares, and other activity about the URL. In some embodiments, the stream of related content is based upon one or more of the canonical identifier, the identification of the user, and a social signal. It should be noted that in some instances the process of block 410 will not produce any related content. In such instances, no content items are produced and a user interface similar to that in FIG. 20 with information inviting the user to be the first to create an item of related content will be presented. Once the stream of related content has been produced, the method 400 continues to generate 412 a user interface element including selected portions of the stream of related content. For example, the element generator 308 can produce the user interface element like those that will be described below with reference to FIGS. 7-20. The method 400 continues by providing 414 the user interface element for presentation display. For example, the user interface element may be sent by the embedded stream widget module 103 to the web browser 150 for presentation and rendering.

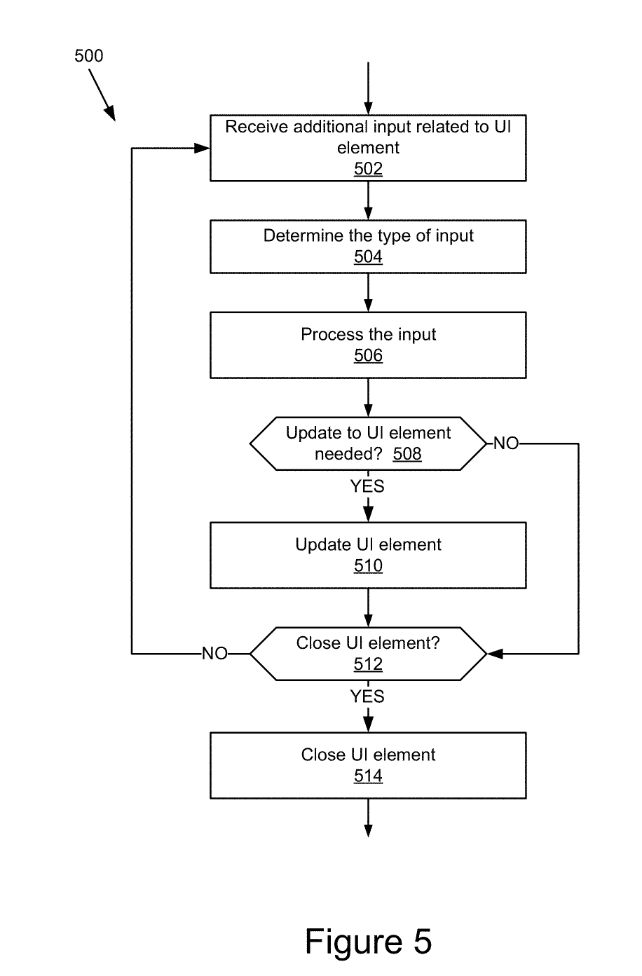

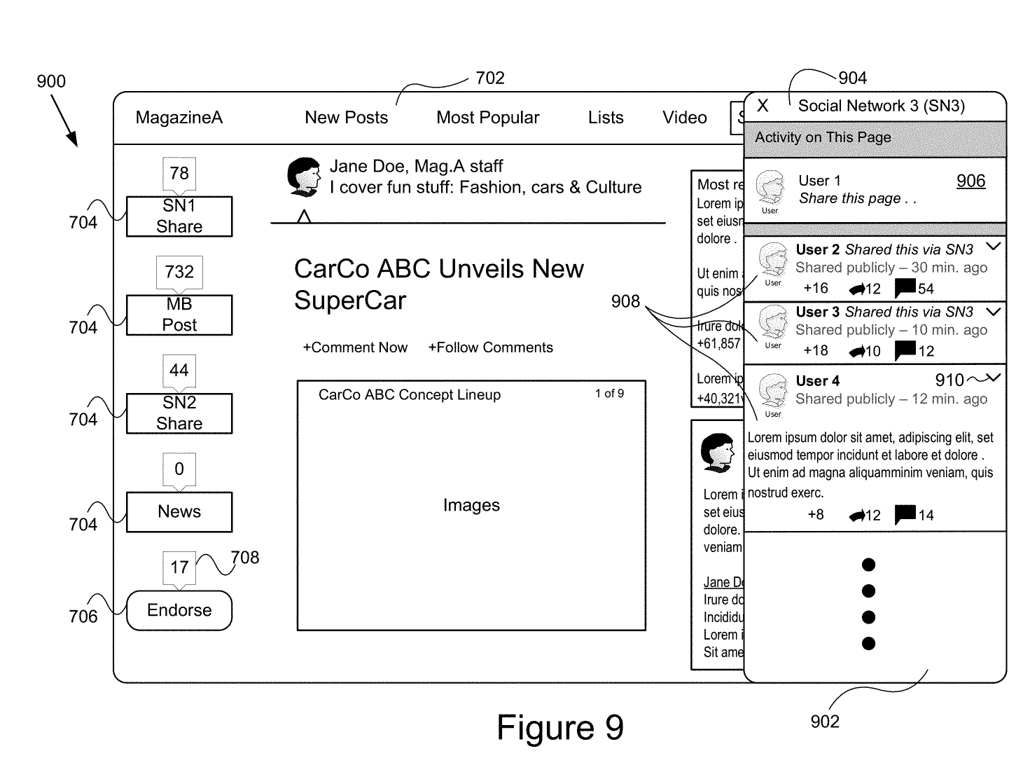

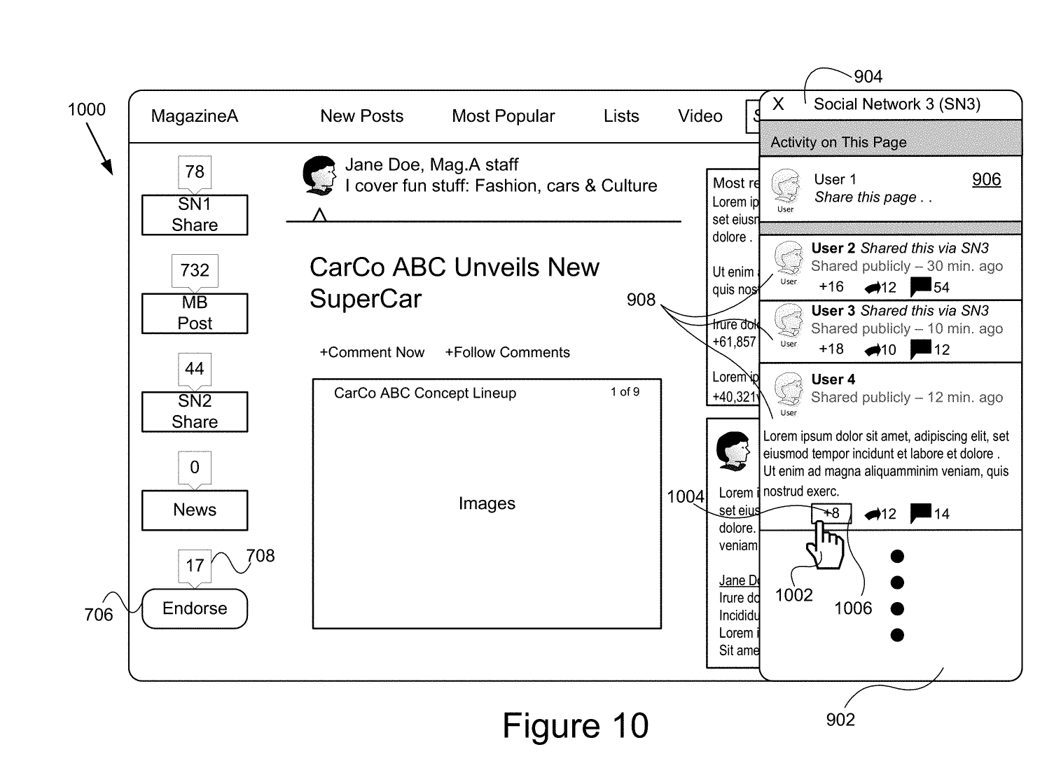

FIG. 5 shows an example method 500 for interacting with a stream content related to a canonical identifier. Before the method 500 of FIG. 5 begins, the method 400 of FIG. 4 has been performed to generate a stream of content related to the canonical identifier and that stream of related content is presented to the user in a user interface element such as depicted and described below with reference to FIG. 9. The method 500 then receives 502 additional input related to the user interface element. As will be described below, any one of the user interfaces shown and described below with reference to FIGS. 9-20 may be presented to the user. Input by the user in any one of these different contexts may be sent to the embedded stream widget module 103. Next, the method 500 determines 504 the type of input received in block 502. Depending on upon the user interface that was being presented, and the specific input of the user, a type of input may be determined. For example, the types may include a request to share the canonical identifier, a request to endorse the canonical identifier, a request to endorse a posted comment related to the canonical identifier, a request for activity related to the canonical identifier, a request to report of use or a request to re-share a posted comment about the canonical identifier, etc. The method 500 continues by processing the input. Processing the input may include performing one of the types of actions described above and generating an update to the user interface element. In block 506, the method 500 performs the action associated with the type of input. Then the method 500 continues to determine 508 whether the user interface element needs to be updated. If so, the user interface element is updated 510. For example, the user interface may be updated by transitioning from the interface shown in FIG. 9 to another interface shown for example in FIGS. 10-20. If it was determined in block 508 that the user interface does not need to be updated, the method 500 proceeds from block 508 to block 512. In block 512, the method 500 determines whether the input was to close the user interface element. If not, the method 500 returns to step 502 to receive additional input and allow the user to further interact with the updated user interface element. However, if it was determined in block 512 that the input and instruction to close the user interface element then the method 500 closes 514 the user interface element.

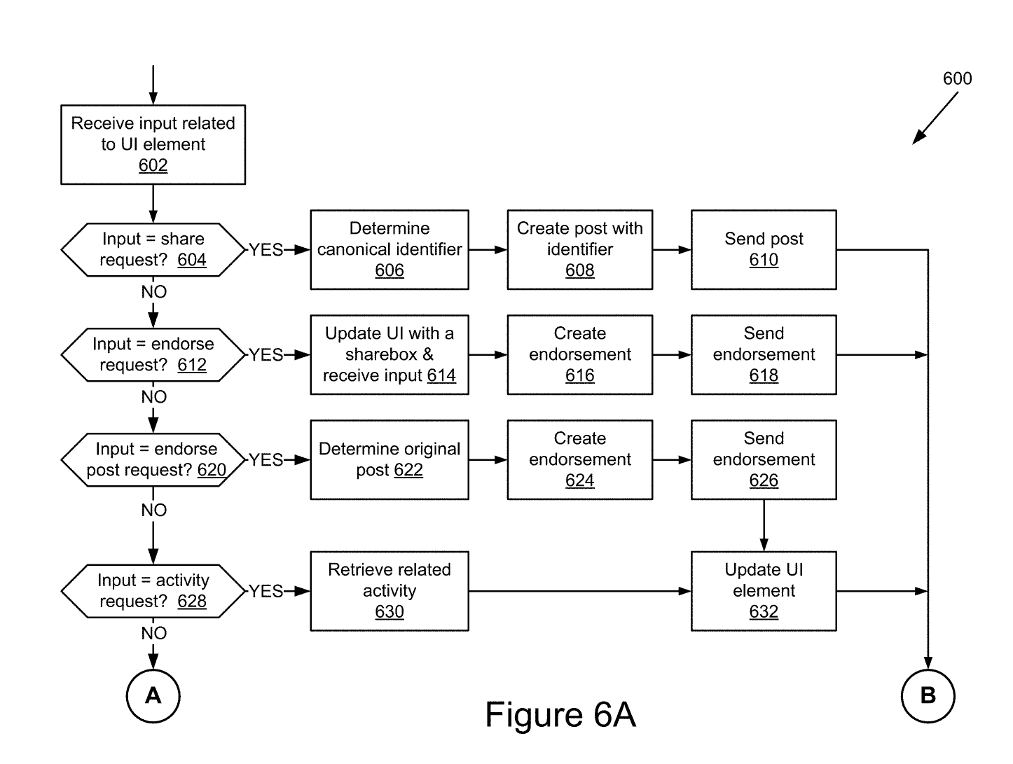

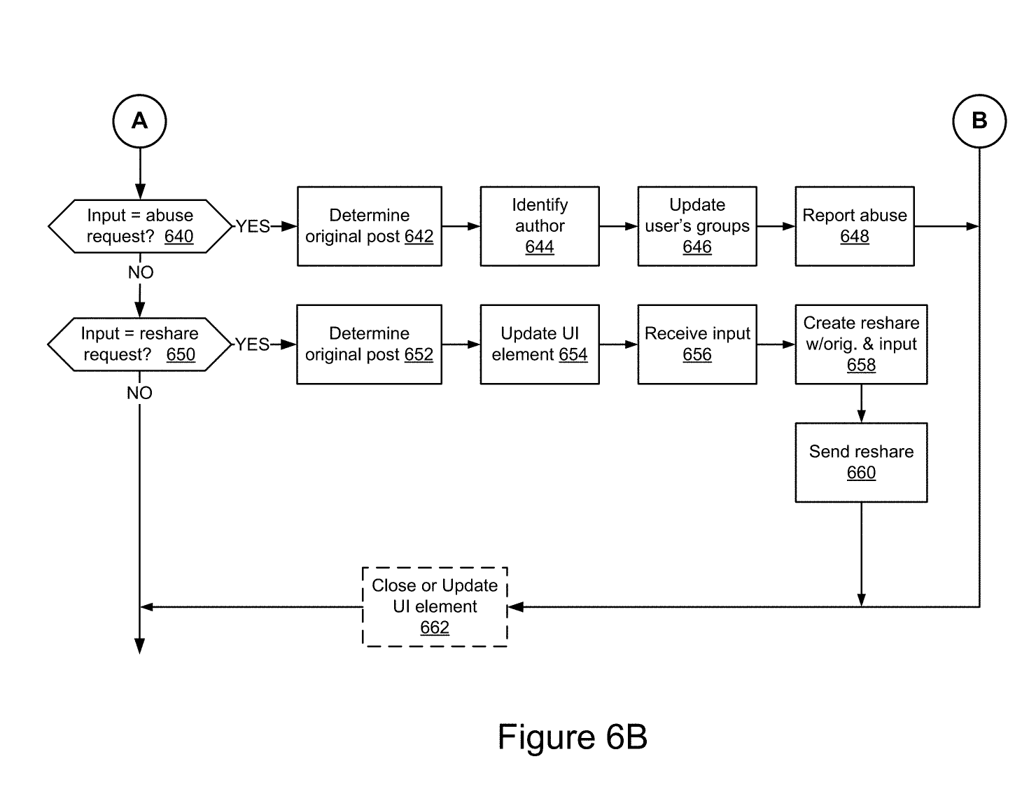

Referring now to FIGS. 6A and 6B, another implementation of a method 600 for interacting with stream content related to a canonical identifier will be described. As shown in FIG. 6A, the method 600 begins by receiving 602 input related to a user interface element. For example, the input may be a cursor over of an element of the webpage, a selection of a button of the webpage, a selection of a button of the user interface element, the inputting of text, the selection of a comment in the user interface element, the selection of an icon in the user interface element indicating endorsements, re-shares, or related comments, etc. Then the method 600 determines 604 whether the input by the user was a share request. If the input from the user was determined to be a share request in block 604, the method 600 continues to determine 606 the canonical identifier. For example, the canonical identifier may be the web address of the webpage over which the user interface element is being displayed. Then the method 600 creates 608 a new comment or post including the canonical identifier and then sends 610 the post. For example, the embedded stream widget module 103 may interact with the user via the user interface element to create the new post including the URL for the webpage and then send the post to the social network application 109. In some embodiments, the user interface element is similar to that shown in FIG. 9 and can be used to input the share request. Moreover, in some implementations, the user may input text that will be shared along with the canonical identifier. Next the method 600 proceeds to block 662 of FIG. 6B to close the user interface element. Block 662 is shown with dashed lines to indicate that it is optional. In some embodiments, rather than closing the user interface element after the post has been sent in block 610, the user interface element may be updated to include the new post, ranked among the other posts, and another input is required to close the user interface element.

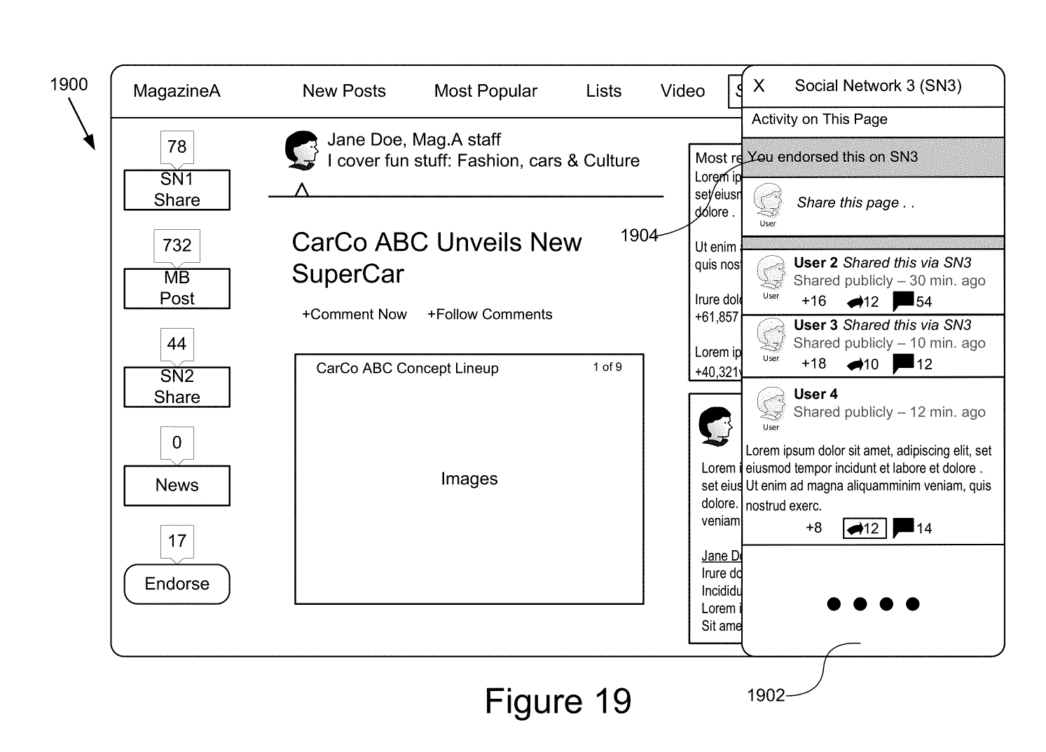

If the input from the user was determined not be a share request in block 604, the method 600 continues to block 612 to determine whether the input was an endorsement request. If so, the method 600 updates 614 the user interface element with the share box and receive additional input from the user via that share box. The method 600 can process additional input from the user to create a new post. For example, an updated user interface element similar to that shown in FIG. 19 can be presented. The method 600 continues to create 616 and endorsement, and send 618 the endorsement to the social network application 109 or to an endorsement server (not shown). If the user input additional text into the share box, a new post is also created and sent to the social network in block 616 and 618. Next, the method 600 closes or updates 662 the user interface element.

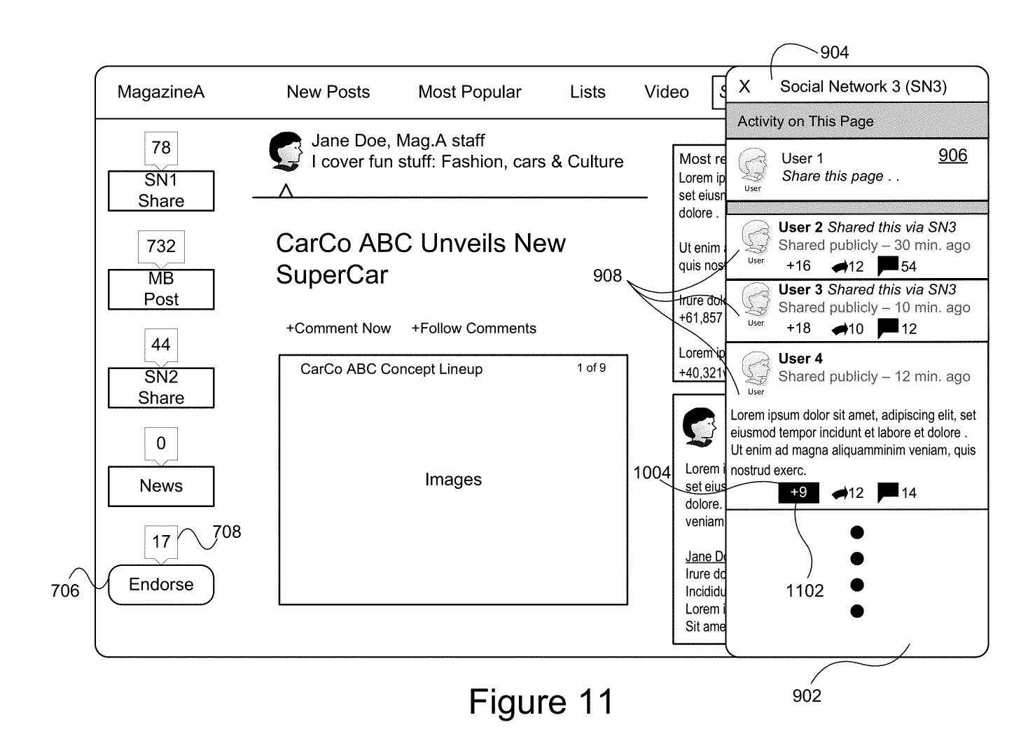

If the input from the user was determined not to be an endorsement request in block 612, the method 600 continues to block 620 to determine whether the input was a request to endorse a particular post shown in the user interface element. If so, the method 600 determines 622 the original post being shown in the user interface element to which the input relates. The method 600 then creates 624 an endorsement and sends 626 the endorsement to the social network application 109 or an endorsement server. Next, the user interface element is updated 632 to indicate that that particular post has an additional endorsement. For example, an endorsement count associated with an endorsement icon may be incremented by one. Example interfaces are shown below in FIGS. 10 and 11. The method 600 then continues to block 662 to close the user interface or updated as has been described above.

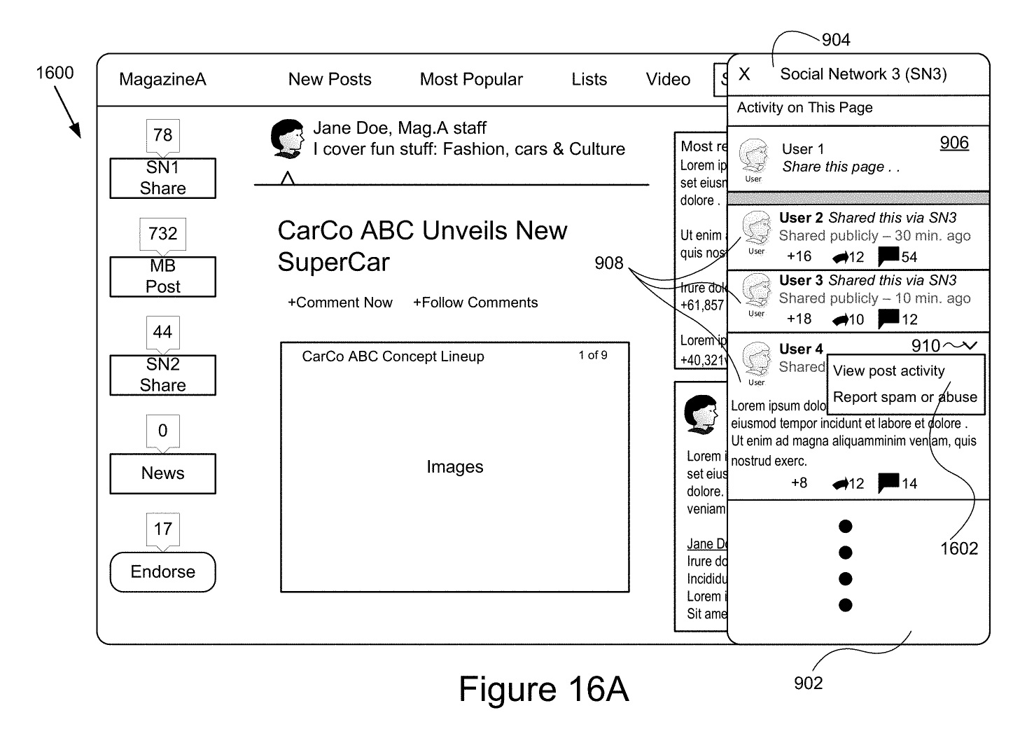

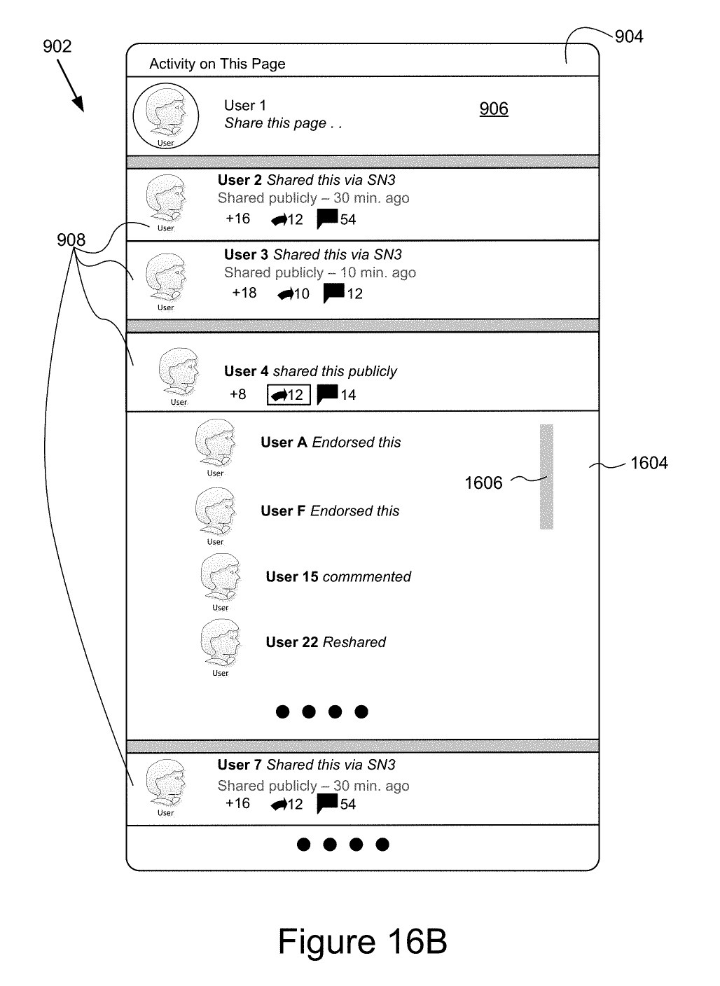

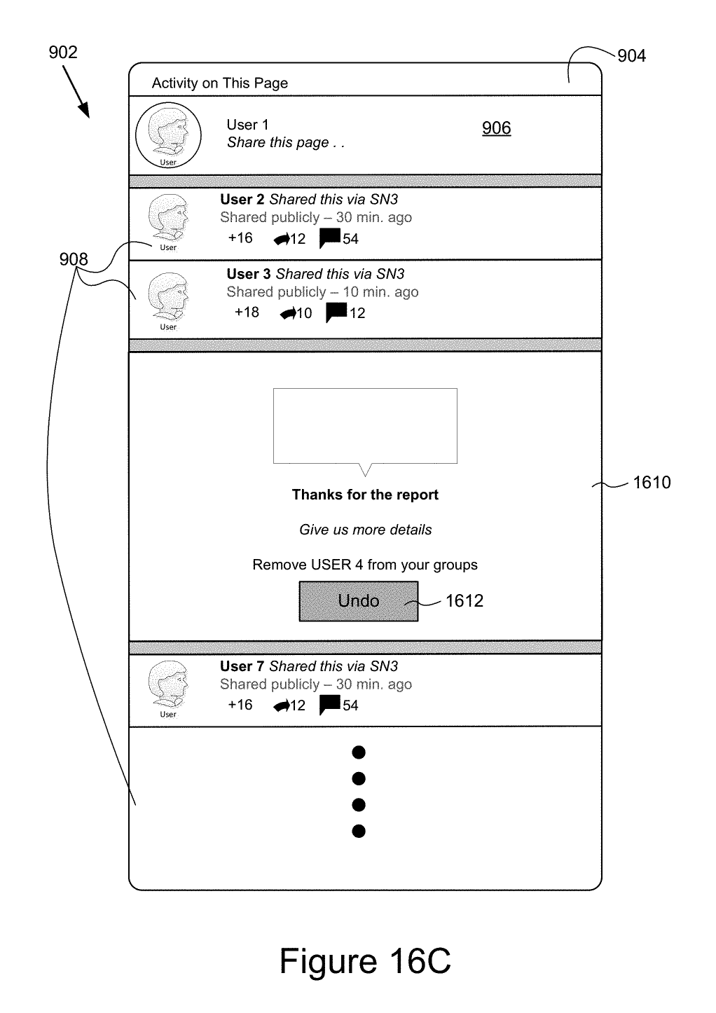

If the input from the user was determined in block 620 not to be a request to endorse a particular post shown by the user interface element, the method 600 continues to block 628 to determine whether the input was a request to retrieve activity associated with the canonical identifier. If so, the method 600 retrieves 630 activity on the social network related to the canonical identifier. In some embodiments, the activity related to the canonical identifier can be used to create a list with the activities ranked based on relevance to the user and her interest. The method 600 continues to update 632 the user interface element to include the list of related activities. An example user interface element showing a list of related activities will be described in more detail below with reference to FIG. 16C. After the user interface element has been updated, the method 600 continues to block 662 to close the user interface or updated as has been described above.

Referring now also to FIG. 6B, if the input from the user was determined not to be a request to retrieve activity in block 628, the method 600 continues to block 640 to determine whether the input was a request to report abuse. If so, the method 600 determines 642 and original post presented in the user interface element that the user has selected. The method 600 then identifies 640 for the author of the original post. The method 600 then updates 646 the groups of the user to remove the identified author. For example, the embedded stream widget module 103 can provide the identified author and commands to remove bad identified author from any groups of the user to the social network application 109. The method 600 then reports 648 the abuse to the social network application, and the user interface element is updated 662 as shown in the example depicted in FIG. 16B. Thus the user can use the user interface element to report abuse such as spam posts or other abusive activities related to the social network and the canonical identifier.

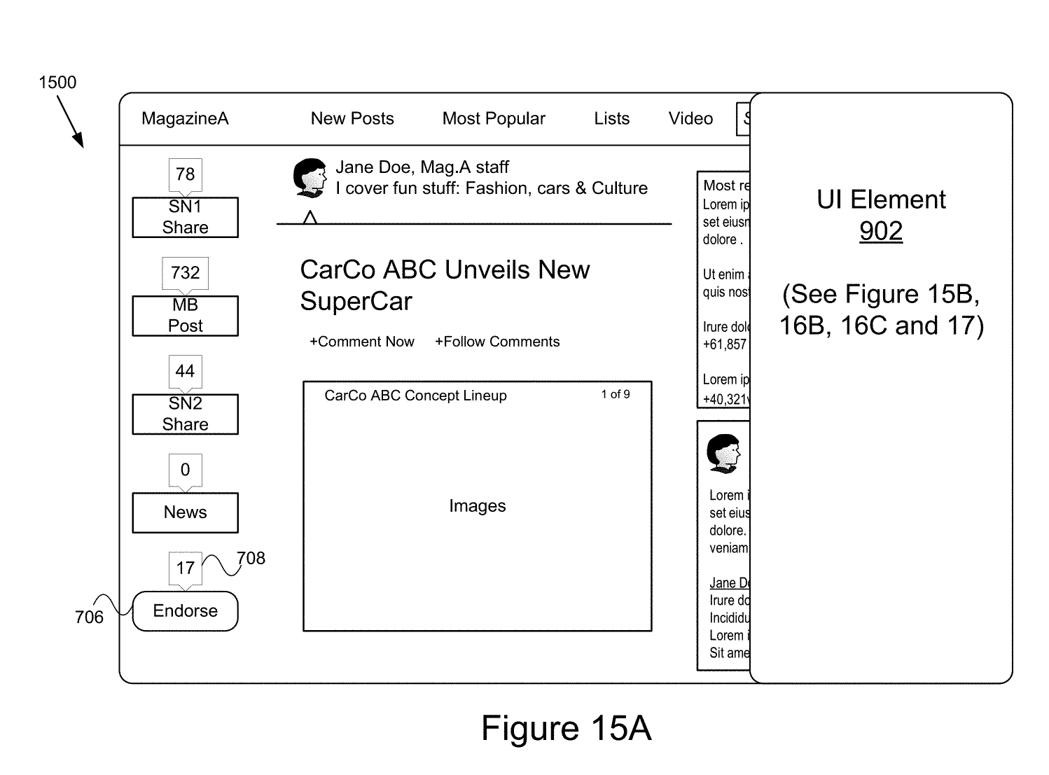

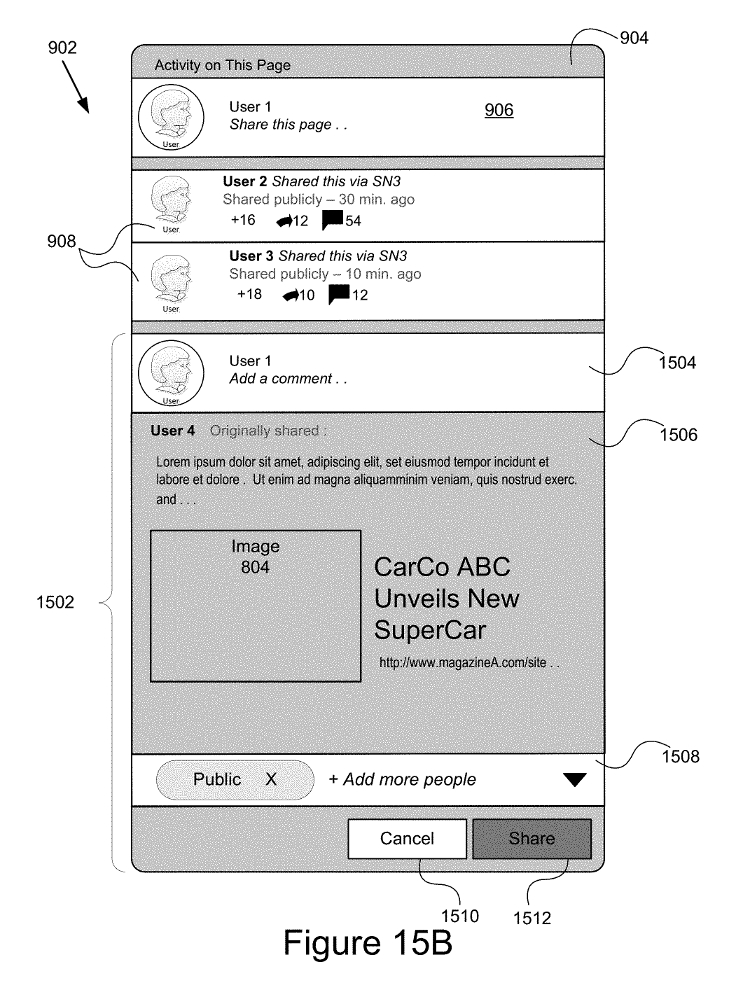

If the input from the user was determined not to be a request to report abuse in block 640, the method 600 continues to determine 650 whether the input was a request to re-share content. If so, the method 600 determines 650 to the original post selected by the user. The method then updates 65 for the user interface element to provide an in-line re-sharing box. One example of such an interface is shown in FIG. 15B. In response to presentation of the updated user interface element, the embedded stream widget module 103 may receive 656 additional input from the user. The user can input additional text or comments, add addressees, input a share commander a cancel command etc. In response to input of the re-share command, the method 600 creates 658 a message including the original comment plus additional input from the user, then re-shares 660 the message. The method 600 then continues to block 662 to close the user interface or updated as has been described above.

It should be understood that the user interface element includes a button for closing the user interface element. When input is received from the user selecting that button, the method 600 removes the user interface element for display. In some embodiments, the user interface element may automatically be closed after having been displayed for a predetermined amount of time. In some embodiments, after the user interface element is presented, it may be automatically closed if the user interacts with portions of the website visible instead of interacting with the user interface element.

Referring now to FIGS. 7-20, various implementations of the user interface element on an example webpage will be described. The present disclosure includes creation and distribution of the widget. The widget uses a canonical ID (URL in this case), retrieves or obtains conversations around the URL and allows operations such as post, re-share, comment, report abuse, etc.

FIG. 7 shows an example web page 700 including one implementation of an embedded stream widget. The graphical representation of the webpage shown in FIG. 7 is merely one example of an article by a magazine including text and graphics by a particular author, Jane Doe. It should be understood that the widget can be embedded on any webpage and provide the functionality as has been described above and that the webpage provided in FIGS. 7-20 are merely one example. It should also be understood that the widget will be described in the context of being associated with an endorsement button or action. The widget could be associated with other buttons or actions other than endorsement in other examples.

The webpage 700 includes a header that is presented near the top of the page. The header includes information identifying the magazine, MagazineA and one or more links to transition to other pages such as new posts, most popular articles, lists, videos etc. The header also includes a search box in which the user can enter text and search the website of MagazineA. Along the left edge of the webpage 700, a plurality of buttons 704, 706 are provided that allow the user to perform an action related to this webpage that the user is viewing. For example, the buttons 704 may allow the user to share the webpage with first or second social network, post the webpage to the microblogging site, or post the website to a news site. One button 706 allows the user to endorse the webpage on a third social network as will be described in more detail below. In this example, the endorse button 706 includes an associated widget that updates how the endorsement button is presented and overlays the user interface element as will be described in more detail below with reference to FIGS. 9-20. Each of the button 704, 706 also has an annotation bubble positioned above it. In this example, the annotation bubble indicates the number of posts related to this webpage are present on each of the respective social networks or services. For example, the first social network has 78 related posts while the microblogging site has 732 posts. In this example webpage 700, the content is an article about a car being released by CarCo that is provided by a regular contributor Jane Doe of the magazine's staff. The webpage may include a short descriptor of the author, the title for the article, images 710 related to the article, text of the article etc. The webpage also includes buttons for commenting on the article or following comments related to the article. The webpage on the right side includes a section 712 of links for other content provided by MagazineA including stats on popularity. Another section 714 provides additional information about the author such as a short bio as well as links to other articles posted by the author.

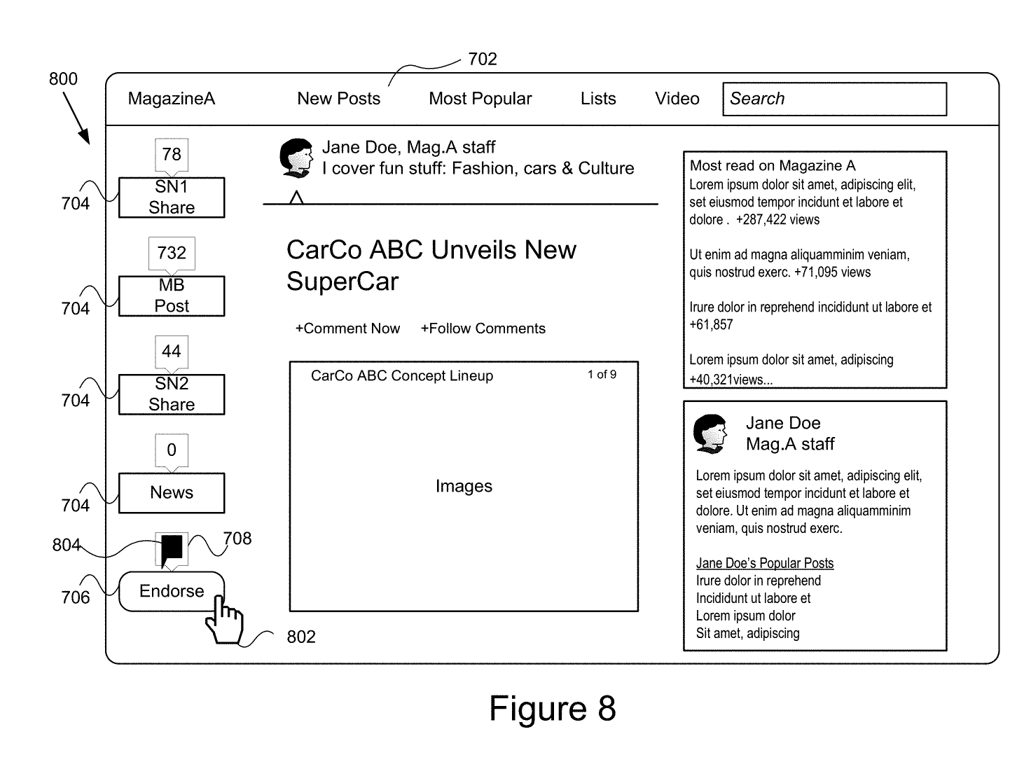

Referring now to FIG. 8, an updated webpage 800 is displayed. This is the same webpage as that of FIG. 7 so like reference numbers will be used to reference components having the same or similar functionality. As noted above, as the user interacts with the endorsement button 706, the webpages updated. In some embodiments, as the user hovers over the endorsement button 706 with the cursor 802, the annotation bubble 708 for the endorsement button 706 is updated. In some embodiments, the annotation bubble 708 for the endorsement button 706 may be updated without user action in response to activity related to the canonical identifier that is taking place on the third social network. FIG. 8 shows one particular animation, a comment bubble icon 804 in the annotation bubble 706, indicating a general conversation about the canonical identifier, e.g., URL, is taking place on the third social network. It should be understood that other icons (not shown) could be displayed within the annotation bubble 708 to provide the user with more feedback about activity that is occurring on the third social network related to the canonical identifier. For example, if there were posts from friends of the user on the third social network the annotation bubble 708 may include a circles icon, or if the URL is trending (becoming popular in posts) a flame icon could be presented within the annotation bubble 708. It should be understood that various other icons may be inserted into the annotation bubble 708 to indicate other status related to the canonical identifier on the third social network. In some embodiments, the icons displayed in the annotation bubble 708 may be presented with a looping animation with each icon presented for a predefined amount of time. Once the user hovers over the annotation bubble 708, the looping will stop and only display the relevant icon.

Referring now to FIG. 9, a graphic representation of an example web page 900 including a user interface element 902 will be described. The webpage 900 is the same as the webpage 700 described above with reference to FIG. 7. However, in FIG. 9, the user interface element 902 is overlaid over a left side portion of the webpage 900. The positioning of the user interface element 902 in the descriptions that follow is merely one example. The user interface element 902 could alternatively be positioned over a left side portion, a top portion or a bottom portion of the webpage 900. The user interface element 902 is shown with animation sliding from the periphery of the webpage 900 towards the center to cover a portion of it as depicted in FIG. 9. In some embodiments, interacting with the endorsement button 706 causes the user interface element 902 to be presented, e.g., transitions the display shown in FIG. 7 to that shown in FIG. 9. In particular, selecting or clicking upon the annotation bubble 708 corresponding to the endorsement button 706 causes of the user interface element 902 to be displayed as depicted in FIG. 9. In some embodiments, selecting or clicking upon the annotation bubble 708 corresponding to the endorsement button 706 when the user interface element 902 is being displayed acts as a toggle button and causes the user interface element 902 to close. In some embodiments, selecting the endorsement button 706 causes the user interface element 902 to be displayed as depicted in FIG. 19. In some embodiments, the user interface will automatically close after a predetermined amount of time (e.g., 3 to 5 seconds) if the user does not interact with the user interface element e.g. hover over it or take some other action.

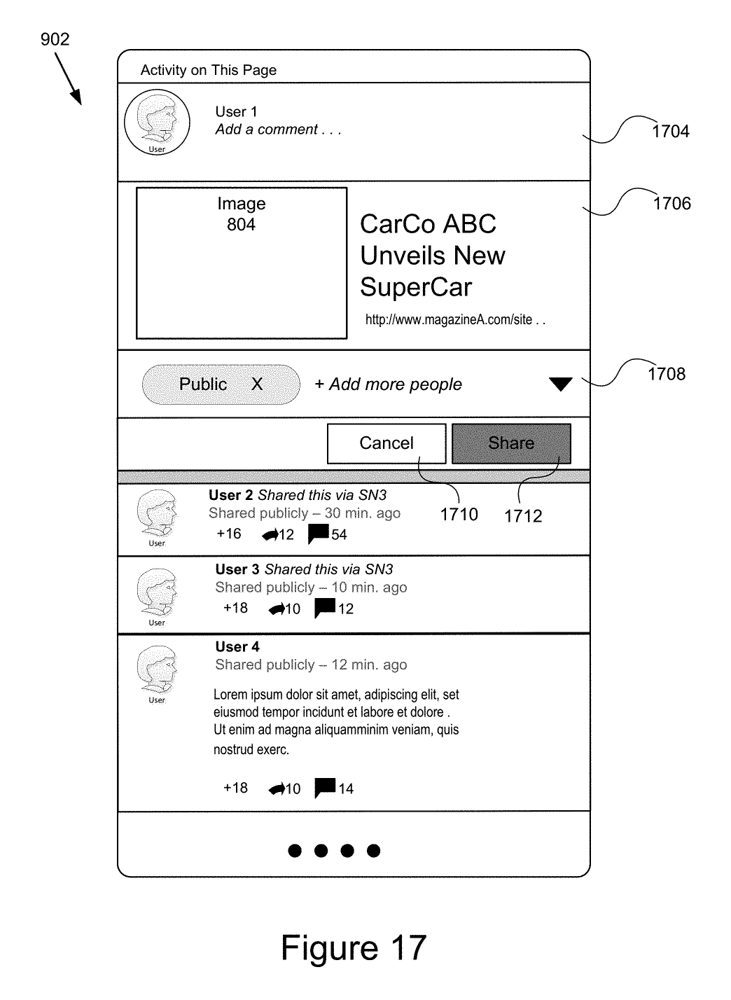

The user interface element 902 includes a header 904, a share action 906, and one or more posts 908. The header 904 includes an identifier of the social network from which the stream of content related to the canonical identifier in the user interface element 902 is being produced. The header 904 also includes a close button to close the user interface element 902. The share action 906 includes an image of the user (in this example User 1), instructions and when selected, the user interface element 902 is updated to the one shown in FIG. 17. The plurality of posts 908 are shown in the user interface element 902 below the share action 906. Each of the posts 908 includes an image or icon associated with the user, the user name, and an indication of how the post was shared. The post 908 may also include when the post was shared and whether was shared publicly or privately. The post 908 may include text images or other content as well. The post 908 may also include action buttons for endorsing, re-sharing and commenting as well as counts indicating the number of times those actions have already been taken by others related to the canonical identifier. In some embodiments, the posts 908 are ordered or ranked based upon affinity to the user. The posts 908 may also include a drop-down menu to retrieve post activity or report abuse or spam.

Referring now to FIG. 10, a graphic representation of an example web page 1000 including the user interface element 902 will be described. FIG. 10 illustrates how the user interface element 902 is updated as the user interacts with it. For example, as the user moves the cursor 1002 over the endorsement button 1004 of the third post 908 (e.g., the post by User 4), the endorsement button 1004 is highlighted 1006. In other words, as the user moves the cursor 1002 over the endorsement button 1004, the user interface element 902 transitions from the user interface element 902 shown in FIG. 9 to that shown in FIG. 10. In this example, the highlighting 1006 is a box around the endorsement button 1004. It should be understood that the highlighting 1006 may take a variety of other forms such as shading, shapes, coloring etc. around the endorsement button 1004 to display it in a visually distinct manner.

If the user selects the endorsement button 1004 of the third post 908, the user interface element 902 is updated from the user interface element 902 of FIG. 10 to the user interface element 902 of FIG. 11. As depicted, the endorsement button 1004 is shown with the count incremented by one and with different highlighting 1102. In particular, the count for the endorsement button 1004 of the third post 908 was “8” in FIG. 10 while the count for the endorsement button 1004 of the third post 908 is “9” in FIG. 11 after being selected by the user. Additionally, the highlighting 1006 was an outline box around the endorsement button 1004, while the highlighting 1102 of the endorsement button 1004 is a solid box for the endorsement button 1004 indicating that the endorsement button 1004 was selected. It should be understood that various types of different highlighting can be used to distinguish between a hover over action on the endorsement button 1004 and selection of the endorsement button 1004.

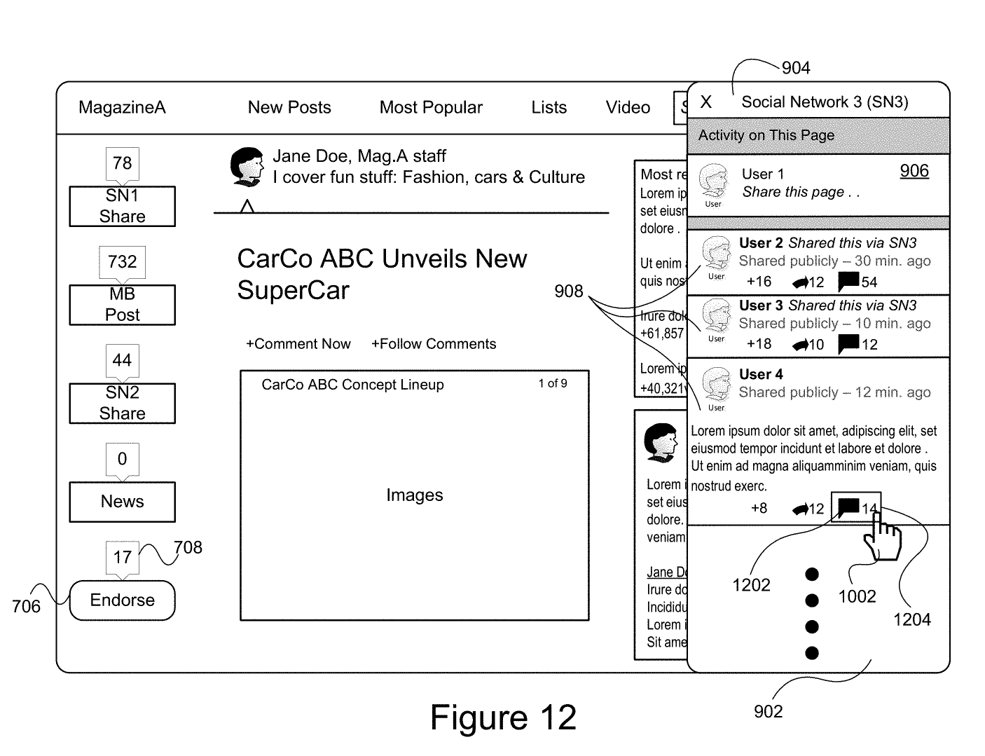

Similar to the user interaction with the endorsement button 1004, the user may interact with comment buttons 1202 associated with each of the posts 908 in the user interface element 902. FIG. 12 shows an updated user interface element 902 once the user has positioned the cursor 1002 over the comment button 1202. For example, as the user moves the cursor 1002 over the comment button 1202 of the third post 908, the comment button 1202 is displayed highlighted 1204. In other words, as the user moves the cursor 1002 over the comment button 1202, the user interface is updated from the user interface element 902 shown in FIG. 9 to that shown in FIG. 12. In this example, the highlighting 1204 is a box around the comment button 1202. Again, it should be understood that the highlighting 1204 may take a variety of other forms such as shading, shapes, coloring etc. around the comment button 1202 to display it in a visually distinct manner.

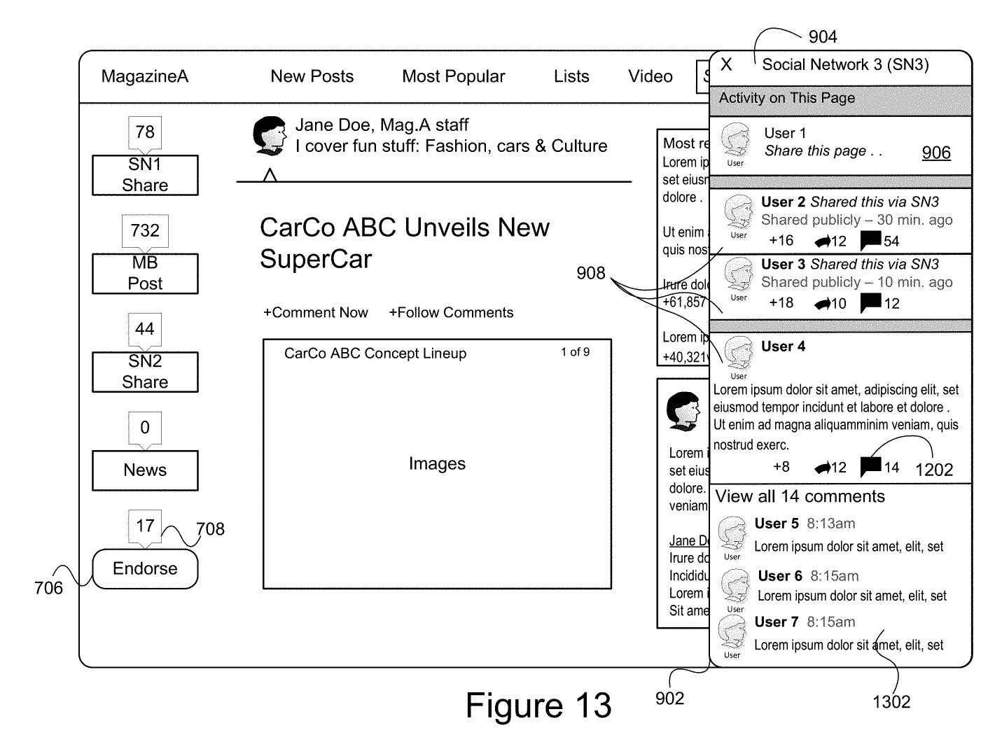

If the user selects the comment button 1202 of the third post 908, the user interface element 902 is updated from the user interface element 902 of FIG. 12 to the user interface element 602 of FIG. 13. As depicted, the comment button 1202 is displayed in its original state with no highlighting. Responsive to the selection of the comment button 1202, the third post 908 is expanded to include a comment section 1302. The comment section 1302 includes a link to view the comments related to the third post 908 as well as a list of the top comments with the greatest affinity to the user. In this example, there is a link that is selectable by the user to “view all 14 comments” associated with the third post 908. Below the link, a few selected comments, the user that made the comment, and the time of the comment are shown in the comment section 1302. In some embodiments, the selection of the comment button 1202 will show a predefined number of comments (e.g., 3-5 comments) in the comment section 1302. In some embodiments, the user interface element 902 includes a comment box (not shown) in which the user can input a comment related to the third post 908.

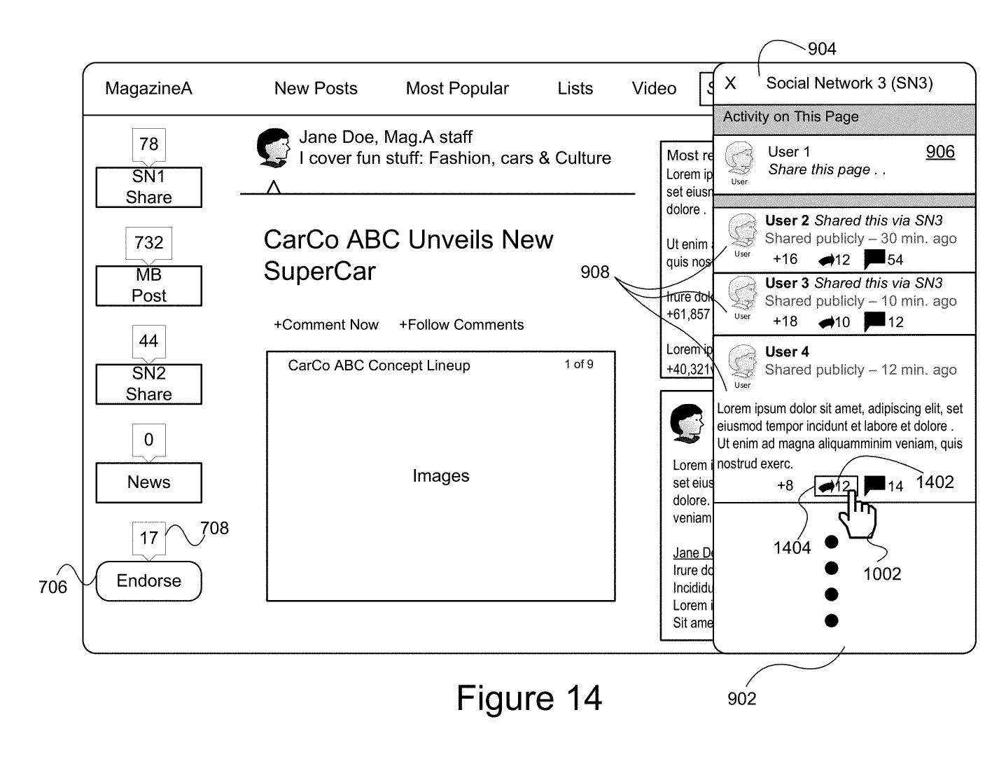

Similar to the user interaction with the endorsement button 1004, the user may interact with reshare buttons 1402 associated with each of the posts 908 in the user interface element 902. FIG. 14 shows an updated user interface element 902 once the user has positioned the cursor 1002 over the reshare button 1402. For example, as the user moves the cursor 1002 over the reshare button 1402 of the third post 908, the reshare button 1402 is displayed highlighted 1404. In other words, as the user moves the cursor 1002 over the reshare button 1402, the user interface is updated from the user interface element 902 shown in FIG. 9 to that shown in FIG. 14. In this example, the highlighting 1404 is a box around the reshare button 1402. Again, it should be understood that the highlighting 1404 may take a variety of other forms such as shading, shapes, coloring etc. around the reshare button 1402 to display it in a visually distinct manner.

If the user selects the reshare button 1402 of the third post 908, the user interface element 902 is updated from the user interface element 902 of FIG. 12 to the user interface element 602 of FIGS. 15A and 15B. FIG. 15A shows the webpage 1500 including the user interface element 902 so that the context of FIGS. 15B, 16B, 16C and can be better understood. FIG. 15B shows an updated user interface element 902 including an in-line re-share flow 1502. The in-line re-share flow 1502 includes a comment of box 1504, the original post, portions of the webpage 1506, address box 1508, and action buttons 1510, 1512. The comment box 1504 includes a picture or icon representing the first user and an area for the user to input comments related to the re-share. The original post that is being re-shared and portions of the original webpage being viewed are shown in a content area 1506. The address box 1508 allows the user to mark the re-share public or private and also includes a drop-down menu to add additional addressees. Finally, the in-line re-share flow 1502 includes action buttons including a cancel button 1510 and the share button 1512. Selection of the cancel button 1510 by the user will transition the user interface element from that of FIG. 15B back to that of FIG. 9. Selection of the re-share button 1512 causes the original post along with the comments from the user to be re-shared in the social network application 109 with the addressees identified in the addressee box 1508.

Referring back to FIG. 9, each of the posts 908 includes a selectable drop-down button 910. Selection of the drop-down button 910 causes the user interface element 902 to be modified from that of FIG. 9 to that of FIG. 16A. As shown in FIG. 16A, the selection of the drop-down button 910 causes a drop-down box 1602 to be displayed. The drop down box 1602 includes two options: a) view post activities; or b) report spam or abuse. If the user selects the first option, the user interface element 902 is updated from that of FIG. 16A to that of FIG. 16B. As depicted in FIG. 16B, a window 1604 includes a list of activities related to the post 908. These activities can include endorsements, comments, re-shares or various other activities on the social network that users may take with regard to the third post 908. Each of the activities shows an image representing the user, a user ID and the specific activity that was undertaken by that user. The window 1604 includes a scroll bar 1606 selectable by the user to show other activities in the list but not presently displayed with in the window 1604. If the user selects the second option, the user interface element 902 is updated from that of FIG. 16A to that of FIG. 16C. As depicted in FIG. 16C, the user interface element 902 is updated and the third post 908 is replaced with an abuse notification 1610 indicating that the author of the selected post has been removed from the groups of the user. The abuse notification 1610 may also include an undo button 1612 in the event the user mistakenly selected the report abuse option from the drop-down box 1602.

Referring now to FIG. 17, an updated user interface element 902 for sharing the webpage 700. In particular, the updated user interface element 902 of FIG. 17 can be presented once the user selected the share action 906 of the user interface element 902 of FIG. 9. The updated user interface element 902 is similar to the in-line re-share flow 1702 includes a comment of box 1704, a content area 1706, an address box 1708, and action buttons 1710, 1712. The comment box 1704 includes a picture or icon representing the first user and area for the user to input comments to share. The original post that is being shared and portions of the original webpage being viewed are shown in a content area 1706. The address box 1708 allows the user to mark the share public or private and also includes a drop-down menu to add additional addressees. Finally, the action buttons include a cancel button 1710 and the share button 1712. Selection of the cancel button 1710 by the user will transition the user interface element from that of FIG. 17 back to that of FIG. 9. Selection of the share button 1712 causes the original post along with the comments from the user to be shared in the social network application 109 with the addressees identified in the addressee box 1708.

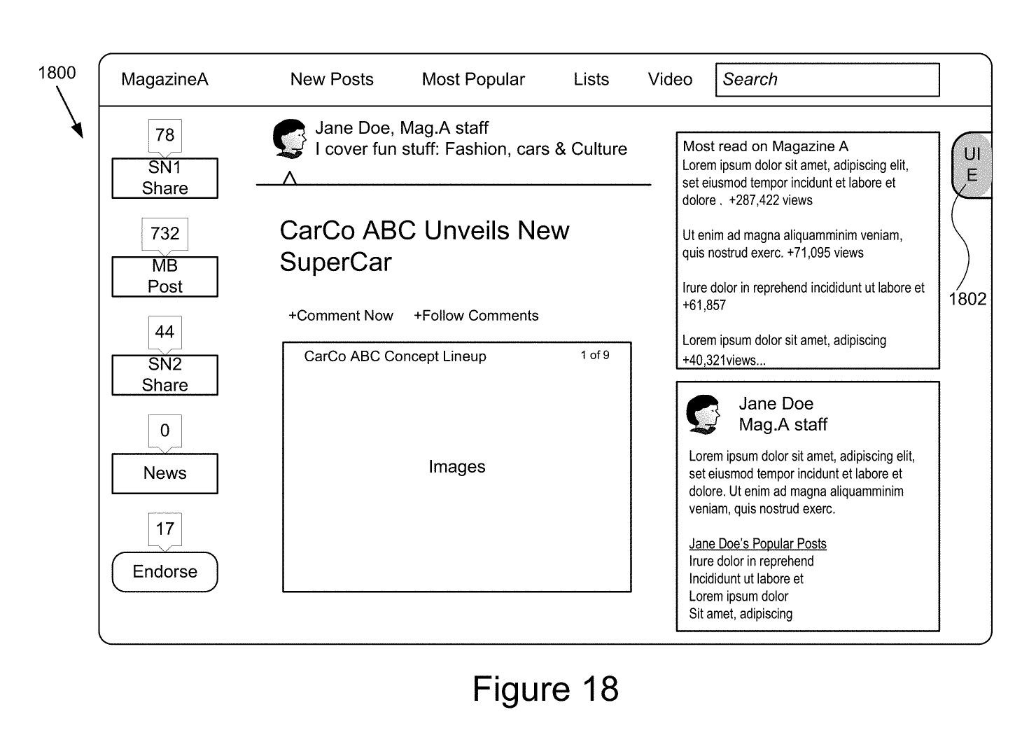

Referring now to FIG. 18, a webpage 1800 after the user interface element 902 has been closed is shown. The webpage 1800 is similar to that described above with reference to FIG. 7; however, the webpage 1800 is updated to include a selectable sticky tab 1802. In this example, the selectable sticky tab 1802 is positioned along the right side of the webpage 1800. Upon selection of the sticky tab 1802 by the user, the user interface element 902 is opened and displayed. For example, selection of the sticky 1802 will transition the interface from the webpage 1800 of FIG. 18 to the webpage 900 of FIG. 9. It should be understood that when the webpage 900 of FIG. 9 is displayed, the stream of content shown in the user interface element 902 is updated to include a current stream of related content.

As has been noted above, if the user selects the endorsed button 706, the web browser 150 of the user is updated to show the webpage 1900 of FIG. 19. In this implementation, the user interface element 1902 is similar to the user interface element 902 of FIG. 9. However, the user interface element 1902 is slightly different because it provides an indication 1904 that the user endorsed this webpage on the third social network. Otherwise, the user interface element 1902 has similar components with similar functionality as has been described above with reference to the user interface element 902 of FIG. 9.

In some cases, the stream producer 306 may not be able to generate any content related to the canonical identifier. In such instances, the user interface element 2002 of FIG. 20 is provided to solicit social network activity about the canonical identifier. The user interface element 2002 is similar to the in-line re-share flow 1502 and the user interface element 902 for sharing referenced with FIG. 17 above. The user interface element 2002 includes a comment box, an address box, and action buttons. The user interface element 2002 also includes a header and a message to solicit or start a conversation about the webpage being viewed.

In addition to the functionality offered by the user interface element 902 described above with reference to FIGS. 9 through 20, the user interface element 902 may be augmented to provide additional information. In some embodiments, the user interface element 902 may also include trend lines, pie charts, or bar graphs representing user activity levels related to the canonical identifier. In some embodiments, the user interface element 982 may also be adapted in format and function for display on mobile devices.

Systems and methods for generating a user interface element for presentation and interaction with stream content related to the canonical identifier have been described. While the present disclosure is described in the context of a social network, it should be understood that the terms “products” and “services” are used interchangeably throughout this specification and are used herein to encompass their plain and ordinary meaning including, but not limited to any online service, online product, online software that provides online endorsement services to users.

In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware. Moreover, the technologies disclosed above primarily in the context of on line services; however, the disclosed technologies apply to other data sources and other data types (e.g., collections of other resources for example images, audio, web pages).

Reference in the specification to “one implementation” or “an implementation” means that a particular feature, structure, or characteristic described in connection with the implementation is included in at least one implementation of the disclosed technologies. The appearances of the phrase “in one implementation” in various places in the specification are not necessarily all referring to the same implementation.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosed technologies can take the form of an entirely hardware implementation, an entirely software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

1. A computer-implemented method comprising:
receiving, using one or more processors, an input related to a widget embedded on a webpage;
receiving, using the one or more processors, a canonical identifier referencing the webpage from the widget embedded on the webpage;
determining, using the one or more processors, an identification for a user;
determining, using the one or more processors, a social signal for the identified user; and
in response to reception of the input and the canonical identifier from the widget embedded on the webpage:
producing, using the one or more processors, a stream of related content using the canonical identifier, the identification for the user and the social signal,
generating, using the one or more processors, a user interface element for display of the stream of related content,
providing, using the one or more processors, the user interface element for presentation to the user on the webpage, the user interface element configured so that when rendered the user interface element is overlaid over a portion of the webpage and the user interface element is viewable contemporaneously with a remaining portion of the webpage,
providing, using the one or more processors, a first option included in the remaining portion of the webpage and controlling the presentation of the user interface element, and in response to an activity on a social network that is related to the canonical identifier, the widget updates the first option to include a type of icon from a plurality of icons based on a type of the activity on the social network that is unrelated to the first option, and each icon indicating a specific status related to the canonical identifier on the social network, and
wherein the user interface element includes a second option to solicit a conversation about the webpage from the user when the stream of related content is empty.

2. The method of claim 1 wherein the input is a user interaction with the widget or a user selection of the widget.

3. The method of claim 1 wherein the canonical identifier is a uniform resource locator.

4. The method of claim 1 comprising:
receiving an additional input related to the user interface element;
creating a message including the canonical identifier; and
sending the message including the canonical identifier.

5. The method of claim 1 comprising:
receiving a request to endorse identified content;
creating an endorsement using the request; and
sending the endorsement.

6. The method of claim 1 comprising:
receiving a request to an additional activity;
determining the additional activity related to the canonical identifier; and
updating the user interface element to show the additional activity related to the canonical identifier.

7. The method of claim 1 comprising:
receiving a request to report abuse;
identifying a post associated with the request;
identifying a second user that authored the post; and
removing one or more posts authored by the second user from the stream of related content.

8. A computer program product comprising a non-transitory computer usable medium including a computer readable program, wherein the computer readable program when executed on a computer causes the computer to perform:
receive an input related to a widget embedded on a webpage;
receive a canonical identifier referencing the webpage from the widget embedded on the webpage;
determine an identification for a user;
determine a social signal for the identified user; and
in response to reception of the input and the canonical identifier from the widget embedded on the webpage:
produce a stream of related content using the canonical identifier, the identification for the user and the social signal,
generate a user interface element for display of the stream of related content,
provide the user interface element for presentation to the user on the webpage, the user interface element configured so that when rendered the user interface element is overlaid over a portion of the webpage and the user interface element is viewable contemporaneously with a remaining portion of the webpage,
provide a first option included in the remaining portion of the webpage and controlling the presentation of the user interface element, and in response to an activity on a social network that is related to the canonical identifier, the widget updates the first option to include a type of icon from a plurality of icons based on a type of the activity on the social network that is unrelated to the first option, and each icon indicating a specific status related to the canonical identifier on the social network, and
wherein the user interface element includes a second option to solicit a conversation about the webpage from the user when the stream of related content is empty.

9. The computer program product of claim 8 wherein the input is a user interaction with the widget or a user selection of the widget.

10. The computer program product of claim 8 wherein the canonical identifier is a uniform resource locator.

11. The computer program product of claim 8 wherein the computer readable program when executed on a computer also causes the computer to perform:
receive an additional input related to the user interface element;
create a message including the canonical identifier; and
send the message including the canonical identifier.

12. The computer program product of claim 8 wherein the computer readable program when executed on a computer also causes the computer to perform:
receive a request to endorse identified content;
create an endorsement using the request; and
send the endorsement.

13. The computer program product of claim 8 wherein the computer readable program when executed on a computer also causes the computer to perform:
receive a request to an additional activity;
determine the additional activity related to the canonical identifier; and
update the user interface element to show the additional activity related to the canonical identifier.

14. The computer program product of claim 8 wherein the computer readable program when executed on a computer also causes the computer to perform:
receive a request to report abuse;
identify a post associated with the request;
identify a second user that authored the post; and
remove one or more posts authored by the second user from the stream of related content.

15. A system comprising:
a processor; and
a memory storing instructions that, when executed, cause the system to:
receive an input related to a widget embedded on a webpage;
receive a canonical identifier referencing the webpage from the widget embedded on the webpage;
determine an identification for a user;
determine a social signal for the identified user; and
in response to reception of the input and the canonical identifier from the widget embedded on the webpage:
produce a stream of related content using the canonical identifier, the identification for the user and the social signal,
generate a user interface element for display of the stream of related content,
provide the user interface element for presentation to the user on the webpage, the user interface element configured so that when rendered the user interface element is overlaid over a portion of the webpage and the user interface element is viewable contemporaneously with a remaining portion of the webpage,
provide includes a first option included in the remaining portion of the webpage and controlling the presentation of the user interface element, and in response to an activity on a social network that is related to the canonical identifier, the widget updates the first option to include a type of icon from a plurality of icons based on a type of the activity on the social network that is unrelated to the first option, and each icon indicating a specific status related to the canonical identifier on the social network, and
wherein the user interface element includes a second option to solicit a conversation about the webpage from the user when the stream of related content is empty.

16. The system of claim 15 wherein the input is a user interaction with the widget or a user selection of the widget.

17. The system of claim 15 wherein the canonical identifier is a uniform resource locator.

18. The system of claim 15 wherein the memory also stores instructions that, when executed, cause the system to:
receive an additional input related to the user interface element;
create a message including the canonical identifier; and
send the message including the canonical identifier.

19. The system of claim 15 wherein the memory also stores instructions that, when executed, cause the system to:
receive a request to endorse identified content;
create an endorsement using the request; and
send the endorsement.

20. The system of claim 15 wherein the memory also stores instructions that, when executed, cause the system to:
receive a request to an additional activity;
determine the additional activity related to the canonical identifier; and
update the user interface element to show the additional activity related to the canonical identifier.

21. The system of claim 15 wherein the memory also stores instructions that, when executed, cause the system to:
receive a request to report abuse;
identify a post associated with the request;
identify a second user that authored the post; and
remove one or more posts authored by the second user from the stream of related content.
